(19) United States
(12) Patent Application Publication
(10) Pub. No.: US 2023/0403705 A1
(43) Pub. Date: Dec. 14, 2023

(54) METHOD AND DEVICE USED IN COMMUNICATION NODES FOR WIRELESS COMMUNICATION

(71) Applicants: Qiaoling YU, Shanghai (CN); Xiaobo ZHANG, Shanghia (CN)

(72) Inventors: Qiaoling YU, Shanghai (CN); Xiaobo ZHANG, Shanghia (CN)

(73) Assignee: SHANGHAI LANGBO COMMUNICATION TECHNOLOGY COMPANY LIMITED, Shanghai, OT (CN)

(21) Appl. No.: 18/207,695

(22) Filed: Jun. 9, 2023

(30) Foreign Application Priority Data
Jun. 10, 2022 (CN) 202210658270.6

(51) Int. Cl. H04W 72/1273; H04W 72/232

(52) U.S. Cl. CPC H04W 72/1273; H04W 72/232

(57) ABSTRACT

The present application provides a method and a device in a communication node for wireless communication. A communication node monitors a PDCCH for a first candidate RNTI set within a first time interval, the first candidate RNTI set comprises at least a first RNTI, and the first RNTI is not a P-RNTI; within a second time interval, a PDCCH for the first candidate RNTI set is not monitored; the first time interval belongs to a given time interval, the second time interval belongs to the given time interval; a first parameter set is used to determine a beginning of the given time interval, the first parameter set comprises at least one of a system frame number or a subframe number or a first time length; a length of the given time interval is related to the first time length, and the first time length is configurable.

### CROSS REFERENCE TO RELATED APPLICATIONS

This application claims the priority benefit of Chinese Patent Application No. 202210658270.6, filed on Jun. 10, 2022, the full disclosure of which is incorporated herein by reference.

### BACKGROUND

### Technical Field

The present application relates to transmission methods and devices in wireless communication systems, and in particular to a transmission method and device related to RRC_INACTIVE state.

### Related Art

New Radio (NR) supports Radio Resource Control (RRC)_INACTIVE state, and until 3rd Generation Partnership Project (3GPP) Rel-16 version, transmitting or receiving data in RRC_INACTIVE state is not supported. Rel-17 carried out a Work Item (WI) of “Small Data Transmission (SDT) in NR_INACTIVE state”, and developed corresponding technical specifications for MO (UL (Uplink))-SDT, allowing small packet transmission for UL-oriented packets in RRC_INACTIVE state. In order to reduce power consumption, reduce signaling overhead, and shorten latency, Rel-18 established a WI of “Mobile Terminated Small Data Transmission (MT (DL (Downlink))-SDT)”, which studied the triggering mechanism of MT-SDT, and supported Random Access (RA)-SDT and Configured Grant (CG)-SDT as uplink responses, and also, studied MT-SDT procedure for initial DL data reception and subsequent UL/DL data transmission in RRC_INACTIVE state.

### SUMMARY

In existing technology, for MO (UL (Uplink) SDT, if an RA-SDT is selected, and after a random access process is successfully completed, a User Equipment (UE) monitors a Physical Downlink Control Channel (PDCCH) for a Cell Radio Network Temporary Identifier (C-RNTI) until the RA-SDT procedure ends; if a CG-SDT is selected, and after an initial transmission of a CG-SDT, a UE monitors a PDCCH for a C-RNTI and a Configured Scheduling RNTI (CS-RNTI) until the CG-SDT procedure ends. When the UE is in RRC_INACTIVE state, if the MT-SDT procedure ends too early, it will lead to frequent triggering an RRC recovery procedure, high signaling overhead and large latency. If the MT-SDT procedure ends too late and the UE continues to monitor a PDCCH, it is not conducive to power saving for the UE. For the MT-SDT, especially for discontinuous or periodic small packets, when the UE can obtain the distribution of downlink data, how to reduce UE power consumption, shorten Transmission delay, and reduce signaling overhead needs to be enhanced.

In response to the above issues, the present application provides a solution to reduce the power consumption of UE in RRC_INACTIVE state. It should be noted that though the present application only took NR system for example in the statement above, it is also applicable to scenarios such as LTE system; furthermore, although the present application provides specific embodiments for MT-Small Packet Transmission (MT-SDT) in RRC_INACTIVE state, it can also be used for scenarios such as Multicast/Broadcast Service or MO-SDT in RRC_INACTIVE state, where similar technical effects can be achieved. Though originally targeted at Uu air interface, the present application is also applicable to PC5 interface. Besides, the present application is not only targeted at scenarios of terminals and base stations, but also at Vehicle-to-Everything (V2X) scenarios, communication scenarios between terminals and relays as well as relays and base stations, where similar technical effects can be achieved. Furthermore, although the original intention of the present application is for terminal and base station scenarios, it is also applicable to communication scenarios of Integrated Access and Backhaul (IAB), where similar technical effects can be achieved. Furthermore, although the original intention of the present application is for terrestrial network scenarios, it is also applicable to non-terrestrial network (NTN) communication scenarios, where similar technical effects can be achieved. Additionally, the adoption of a unified solution for various scenarios contributes to the reduction of hardware complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict.

The present application provides a method in a first node for wireless communications, comprising:

monitoring a PDCCH for a first candidate RNTI set within a first time interval, the first candidate RNTI set comprising at least a first RNTI, the first RNTI being not a Paging-RNTI (P-RNTI);

herein, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, a problem to be solved in the present application comprises: how to reduce UE power consumption for data transmission in RRC_INACTIVE state.

In one embodiment, a problem to be solved in the present application comprises: how to shorten transmission delay for data transmission in RRC_INACTIVE state.

In one embodiment, a problem to be solved in the present application comprises: how to reduce signaling overhead for data transmission in RRC_INACTIVE state.

In one embodiment, a problem to be solved in the present application comprises: how to execute Discontinuous Reception (DRX) for data transmission in RRC_INACTIVE state.

In one embodiment, characteristics of the above method comprise: when the first node is in RRC_INACTIVE state, a PDCCH scrambled by a first RNTI is not continuously monitored, and the first RNTI is not a P-RNTI.

In one embodiment, characteristics of the above method comprise: at least within a second time interval in a given time interval, a PDCCH for the first candidate RNTI set is not monitored.

In one embodiment, characteristics of the above method comprise: a first RNTI is used for unicast.

In one embodiment, characteristics of the above method comprise: a first RNTI is used for multicast.

In one embodiment, advantages of the above method comprise: it can prolong a time for transmission through a first RNTI in RRC_INACTIVE state.

In one embodiment, advantages of the above method comprise: it avoids continuously monitoring a PDCCH for a first RNTI in RRC_INACTIVE state.

In one embodiment, advantages of the above method comprise: reducing UE power consumption.

In one embodiment, advantages of the above method comprise: shortening transmission delay.

In one embodiment, advantages of the above method comprise: reducing signaling overhead.

According to one aspect of the present application, comprising:

within the second time interval, receiving first Downlink Control Information (DCI), and receiving a first paging message;

herein, the first DCI is scrambled by the P-RNTI, the first DCI indicates scheduling information of a Physical Downlink Shared Channel (PDSCH), and the PDSCH is used to carry at least the first paging message.

According to one aspect of the present application, comprising:

at a beginning of the given time interval, starting a first timer;

herein, the second time length is used to determine a running time of the first timer.

According to one aspect of the present application, comprising:

receiving a first Medium Access Control (MAC) Protocol Data Unit (PDU); and

as a response to the first MAC PDU being correctly received, stopping the first timer;

herein, the first MAC PDU comprises at least a first MAC Service data unit (SDU); the first MAC PDU

does not comprise a MAC subheader with a Logical Channel ID (LCID) field set to 59 or 60.

According to one aspect of the present application, comprising:

receiving a first message, the first message indicating that the first node enters into or maintains the RRC_INACTIVE state;

herein, the first message is an RRC message; within a time interval from a time when the first message is received to a beginning of the given time interval, the first node does not receive any RRC message indicating that the first node enters into or maintains the RRC_INACTIVE state.

According to one aspect of the present application, comprising:

transmitting a second message in the RRC_INACTIVE state, the second message being used to initiate a data transmission procedure in the RRC_INACTIVE state; and

accompanying the second message, recovering each radio bearer in a first radio bearer set;

herein, the first radio bearer set comprises at least one radio bearer, and the first radio bearer set does not comprise SRB1.

In one embodiment, data transmission procedure in the RRC_INACTIVE state is used to determine monitoring a PDCCH for a first candidate RNTI set.

In one embodiment, the given time interval is a time interval in a data transmission procedure in the RRC_INACTIVE state.

According to one aspect of the present application, comprising:

receiving a third message in the RRC_INACTIVE state, the third message indicating that the first node performs a data transmission in the RRC_INACTIVE state;

herein, the third message is used to trigger the second message.

According to one aspect of the present application, wherein a first candidate information block set is used to determine that a PDCCH for the first candidate RNTI set is not monitored within the second time interval, the first candidate information block set is used to determine at least the first time length and the second time length, and the first candidate information block set comprises at least one candidate information block.

The present application provides a method in a second node for wireless communications, comprising:

executing a transmission for a first RNTI on a PDCCH, the first RNTI not being a P-RNTI;

herein, a node identified by the first RNTI monitors a PDCCH for a first candidate RNTI set within a first time interval, and the first candidate RNTI set comprises at least the first RNTI; within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

According to one aspect of the present application, wherein within the second time interval, a first DCI is transmitted, and a first paging message is transmitted.

herein, the first DCI is scrambled by the P-RNTI, the first DCI indicates scheduling information of a PDSCH, and the PDSCH is used to carry at least the first paging message.

According to one aspect of the present application, wherein at a beginning of the given time interval, a first timer is started; the second time length is used to determine a running time of the first timer.

According to one aspect of the present application, comprising:

transmitting a first MAC PDU;

herein, the first MAC PDU being correctly received is used to determine stopping the first timer; the first MAC PDU comprises at least a first MAC SDU; the first MAC PDU does not comprise a MAC subheader with an LCID field set to 59 or 60.

According to one aspect of the present application, comprising:

transmitting a first message, the first message indicating that the first node enters into or maintains the RRC_INACTIVE state;

herein, the first message is an RRC message; within a time interval from a time when the first message is received to a beginning of the given time interval, the first node does not receive any RRC message indicating that the first node enters into or maintains the RRC_INACTIVE state.

According to one aspect of the present application, comprising:

receiving a second message in the RRC_INACTIVE state, the second message being used to initiate a data transmission procedure in the RRC_INACTIVE state;

herein, accompanying the second message, each radio bearer in a first radio bearer set is recovered; the first radio bearer set comprises at least one radio bearer, and the first radio bearer set does not comprise SRB1; data transmission procedure in the RRC_INACTIVE state is used to determine monitoring a PDCCH for a first candidate RNTI set.

According to one aspect of the present application, comprising:

transmitting a third message in the RRC_INACTIVE state, the third message indicating that the first node performs a data transmission in the RRC_INACTIVE state;

herein, the third message is used to trigger the second message.

According to one aspect of the present application, wherein a first candidate information block set is used to determine that a PDCCH for the first candidate RNTI set is not monitored within the second time interval, the first candidate information block set is used to determine at least the first time length and the second time length, and the first candidate information block set comprises at least one candidate information block.

The present application provides a first node for wireless communications, comprising:

a first receiver, monitoring a PDCCH for a first candidate RNTI set within a first time interval, the first candidate RNTI set comprising at least a first RNTI, the first RNTI not being a P-RNTI;

herein, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

The present application provides a second node for wireless communications, comprising:

a second transmitter, executing a transmission for a first RNTI on a PDCCH, the first RNTI not being a P-RNTI;

herein, a node identified by the first RNTI monitors a PDCCH for a first candidate RNTI set within a first time interval, and the first candidate RNTI set comprises at least the first RNTI; within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the present application has the following advantages over conventional schemes:
reducing UE power consumption;
shortening transmission delay;
reducing signaling overhead.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of monitoring a PDCCH for a first candidate RNTI set within a first time interval according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of radio signal transmission according to another embodiment of the present application;

FIG. 7 illustrates a flowchart of radio signal transmission according to another embodiment of the present application;

FIG. 8 illustrates a flowchart of radio signal transmission according to another embodiment of the present application;

FIG. 9 illustrates a structure block diagram of a processor in a first node according to one embodiment of the present application;

FIG. 10 illustrates a structure block diagram of a processor in a second node according to one embodiment of the present application;

FIG. 11 illustrates a schematic diagram of a first candidate information block set being used to determine at least a first time length and a second time length according to one embodiment of the present application;

FIG. 12 illustrates a schematic diagram of a first DRX operation according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

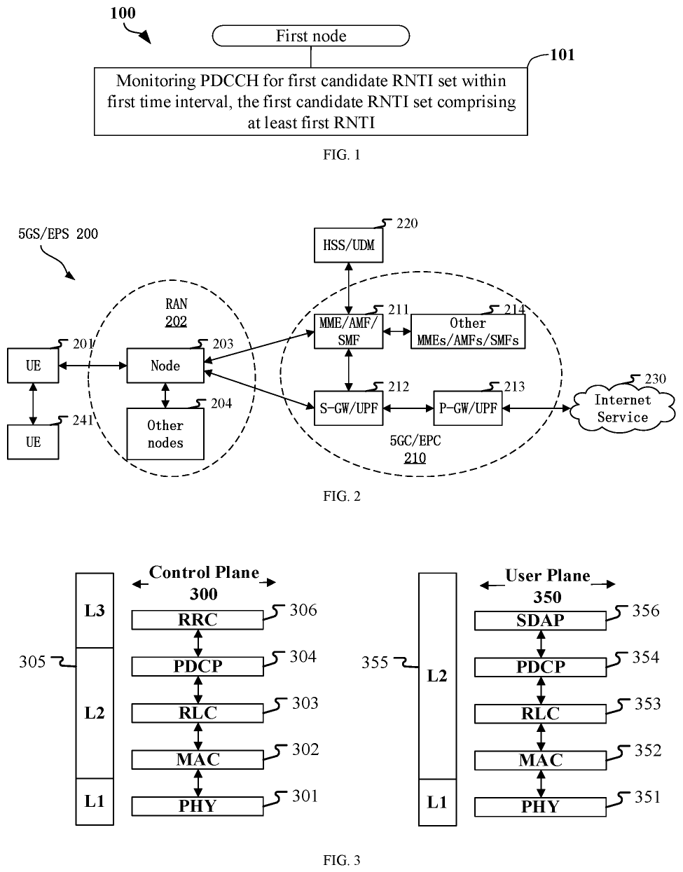

Embodiment 1 illustrates a flowchart of monitoring a PDCCH for a first candidate RNTI set within a first time interval according to one embodiment of the present application, as shown in FIG. 1. In FIG. 1, each step represents a step, it should be particularly noted that the sequence order of each box herein does not imply a chronological order of steps marked respectively by these boxes.

In embodiment 1, a first node in the present application monitors a PDCCH for a first candidate RNTI set within a first time interval in step 101, the first candidate RNTI set comprises at least a first RNTI, the first RNTI is nota P-RNTI; herein, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the first time interval comprises a continuous time interval.

In one embodiment, the first time interval comprises a discontinuous time interval.

In one embodiment, the “monitoring a PDCCH for a first candidate RNTI set” comprises: monitoring a PDCCH for each candidate RNTI in the first candidate RNTI set within a first time interval.

In one embodiment, the “monitoring a PDCCH for a first candidate RNTI set” comprises: monitoring a PDCCH for at least one candidate RNTI in the first candidate RNTI set within a first time interval.

In one embodiment, the “monitoring a PDCCH for a first candidate RNTI set” comprises: detecting whether there exists a transmission for a candidate RNTI in the first candidate RNTI set on the PDCCH.

In one subembodiment of the above embodiment, it is through blind detection.

In one subembodiment of the embodiment, it is through Cyclic Redundancy Check (CRC) detection.

In one subembodiment of the above embodiment, it is through maximum likelihood detection.

In one subembodiment of the above embodiment, it is through minimum variance detection.

In one embodiment, the first candidate RNTI set does not comprise a P-RNTI.

In one embodiment, the first candidate RNTI set comprises a P-RNTI.

In one embodiment, the first candidate RNTI set does not comprise a Group RNTI (G-RNTI).

In one embodiment, the first candidate RNTI set comprises a G-RNTI.

In one embodiment, the first candidate RNTI set does not comprise a Group Configured Scheduling RNTI (G-CS-RNTI).

In one embodiment, the first candidate RNTI set comprises a G-CS-RNTI.

In one embodiment, the first candidate RNTI set only comprises a C-RNTI, and the first RNTI is the C-RNTI.

In one embodiment, the first candidate RNTI set only comprises a C-RNTI and a CS-RNTI, and the first RNTI is one of the C-RNTI or the CS-RNTI.

In one embodiment, the first candidate RNTI set only comprises a G-RNTI, and the first RNTI is the G-RNTI.

In one embodiment, the first candidate RNTI set only comprises a G-RNTI and a G-CS-RNTI, and the first RNTI is one of the G-RNTI or the G-CS-RNTI.

In one embodiment, the first candidate RNTI set comprises at least one of a C-RNTI or a CS-RNTI, and the first candidate RNTI set does not comprise a P-RNTI; the first RNTI is any candidate RNTI in the first candidate RNTI set.

In one embodiment, the first candidate RNTI set comprises at least one of a G-RNTI or a G-CS-RNTI, and the first candidate RNTI set does not comprise a P-RNTI; the first RNTI is any candidate RNTI in the first candidate RNTI set.

In one embodiment, the first candidate RNTI set comprises at least one of a C-RNTI or a CS-RNTI or a G-CS-RNTI or a G-RNTI, and the first candidate RNTI set does not comprise a P-RNTI; the first RNTI is any candidate RNTI in the first candidate RNTI set.

In one embodiment, the first candidate RNTI set comprises at least one of a C-RNTI or a CS-RNTI, and the first candidate RNTI set comprises a P-RNTI; the first RNTI is any candidate RNTI other than a P-RNTI in the first candidate RNTI set.

In one embodiment, the first candidate RNTI set comprises at least one of a G-RNTI or a G-CS-RNTI, and the first candidate RNTI set comprises a P-RNTI; the first RNTI is any candidate RNTI other than a P-RNTI in the first candidate RNTI set.

In one embodiment, the first candidate RNTI set comprises at least one of a C-RNTI or a CS-RNTI or a G-CS-RNTI or a G-RNTI, and the first candidate RNTI set comprises a P-RNTI; the first RNTI is any candidate RNTI other than a P-RNTI in the first candidate RNTI set.

In one embodiment, the first RNTI indicates the first node.

In one embodiment, the first RNTI indicates only the first node within a first cell.

In one embodiment, the first RNTI indicates at least one node within a first cell, and the first node is a node in the at least one node.

In one embodiment, the first RNTI is an RNTI of the first node.

In one embodiment, the first RNTI is not used for paging.

In one embodiment, the first RNTI is not used for MBS broadcast.

In one embodiment, the first RNTI is not used for paging, and the first RNTI is not used for MBS broadcast.

In one embodiment, the first RNTI is not used for System Information change notification.

In one embodiment, the first RNTI is any candidate RNTI in the first candidate RNTI set.

In one embodiment, the first RNTI is a C-RNTI.

In one embodiment, the first RNTI is a CS-RNTI.

In one embodiment, the first RNTI is any of a CS-RNTI or a C-RNTI.

In one embodiment, the first RNTI is a G-RNTI.

In one embodiment, the first RNTI is a G-CS-RNTI.

In one embodiment, the first RNTI is any of a CS-RNTI or a C-RNTI or a G-RNTI or a G-CS-RNTI.

In one embodiment, the second time interval comprises a continuous time interval.

In one embodiment, the second time interval comprises a discontinuous time interval.

In one embodiment, the “within a second time interval, a PDCCH for the first candidate RNTI set not being monitored” comprises: within a second time interval, a PDCCH for each candidate RNTI in the first candidate RNTI set is not required to be monitored.

In one embodiment, the “within a second time interval, a PDCCH for the first candidate RNTI set not being monitored” comprises: within a second time interval, not requiring to monitor a PDCCH for the first candidate RNTI set.

In one embodiment, the “within a second time interval, a PDCCH for the first candidate RNTI set not being monitored” comprises: within a second time interval, if it is not required to monitor a PDCCH for any candidate RNTI in the first candidate RNTI set, not requiring to monitor a PDCCH for the first candidate RNTI set.

In one embodiment, a sum of a length of the first time interval and a length of the second time interval is equal to the first time length.

In one embodiment, a sum of a length of the first time interval and a length of the second time interval is not greater than the first time length.

In one embodiment, each time in the first time interval does not belong to the second time interval.

In one embodiment, the first time interval and the second time interval are non-overlapping in time domain.

In one embodiment, the system frame number is System Frame Number (SFN).

In one embodiment, the system frame number is a hyper SFN.

In one embodiment, the system frame number is a number of system frame.

In one embodiment, the system frame number comprises a positive integer number of bit(s).

In one embodiment, the system frame number comprises 10 bits.

In one embodiment, before the first DRX operation starts, the system frame number is determined.

In one embodiment, at least one RRC message is used to determine the system frame number.

In one embodiment, at least system message is used to determine the system frame number.

In one embodiment, at least Physical broadcast channel (PBCH) is used to determine the system frame number.

In one embodiment, at least Synchronization Signal/PBCH block (SSB) is used to determine the system frame number.

In one embodiment, at least System Information Block 1 (SIB1) is used to determine the system frame number.

In one embodiment, at least System Information (SI) is used to determine the system frame number.

In one embodiment, at least Master Information Block (MIB) is used to determine the system frame number.

In one embodiment, a systemFrameNumber field in at least MIB is used to determine the system frame number.

In one embodiment, at least MIB and PBCH are used to determine the system frame number.

In one embodiment, a systemFrameNumber field in an MIB indicates 6 most significant bits (MSBs) of the system frame number; a PBCH transport block carries 4 Least Significant Bits (LSBs) of the system frame number.

In one embodiment, the subframe number is a number of subframe.

In one embodiment, the subframe number is a number in the system subframe.

In one embodiment, the subframe number is subframe number.

In one embodiment, a system frame number indicates a system frame.

In one embodiment, a system frame is indexed by a system frame number.

In one embodiment, a system frame comprises 10 subframes.

In one embodiment, a length of a system frame is 10 ms, and a length of a subframe is 1 ms.

In one embodiment, a subframe is indexed by a subframe number.

In one embodiment, a subframe number identifies a subframe in a system frame.

In one embodiment, for definitions of the system frame and subframe, refer to 3GPP TS 38 series protocol.

In one embodiment, a beginning of the given time interval is related to the first parameter set.

In one embodiment, a beginning of the given time interval is calculated according to a parameter in the first parameter set.

In one embodiment, a beginning of the given time interval is derived according to parameters in the first parameter set.

In one embodiment, the first parameter set comprises at least one of system frame number or subframe number or a first time length or a first offset.

In one embodiment, the first parameter set comprises at least one of system frame number or subframe number or a first time length or a first offset or a second offset.

In one embodiment, the first parameter set comprises a system frame number, a subframe number and the first time length.

In one embodiment, the first parameter set comprises at least a system frame number, a subframe number, and the first time length.

In one embodiment, the first parameter set comprises a system frame number, a subframe number, the first time length and the first offset.

In one embodiment, the first parameter set comprises at least a system frame number, a subframe number, the first time length and the first offset.

In one embodiment, the first parameter set comprises a system frame number, a subframe number, the first time length, the first offset and the second offset.

In one embodiment, the first parameter set comprises at least a system frame number, a subframe number, the first time length, the first offset and the first offset.

In one embodiment, if [(system frame number×10)+subframe number] modulo (the first time length)=(the first offset) modulo (the first time length), a subframe indexed by the subframe number is used to determine a beginning of the given time interval.

In one subembodiment of the embodiment, a time after a beginning of a subframe indexed by the subframe number is through the second offset is a beginning of the given time interval.

In one subembodiment of the embodiment, a time after a beginning of a subframe indexed by the subframe number is through the second offset is a beginning of the given time interval.

In one embodiment of the above embodiment, a beginning of the given time interval is related to a beginning of a subframe indexed by the subframe number.

In one embodiment, if [(system frame number×10)+subframe number] modulo (the first time length)=(the first offset), a subframe indexed by the subframe number is used to determine a beginning of the given time interval.

In one subembodiment of the embodiment, a time after a beginning of a subframe indexed by the subframe number is through the second offset is a beginning of the given time interval.

In one subembodiment of the embodiment, a time after a beginning of a subframe indexed by the subframe number is through the second offset is a beginning of the given time interval.

In one embodiment of the above embodiment, a beginning of the given time interval is related to a beginning of a subframe indexed by the subframe number.

In one embodiment, the meaning of the modulo is: modulo.

In one embodiment, the meaning of the modulo is: Mod.

In one embodiment, the meaning of the modulo is: modulo operation.

In one embodiment, the meaning of the modulo is: remainder operation.

In one embodiment, [(system frame number×10)+subframe number] modulo (the first time length) is equal to a remainder obtained by dividing [(system frame number×10)+subframe number] by (the first time length).

In one embodiment, 7 modulo 5=2.

In one embodiment, 13 modulo 5=3.

In one embodiment, a length of the given time interval being related to the first time length comprises: a length of the given time interval is not less than the first time length.

In one embodiment, a length of the given time interval being related to the first time length comprises: a length of the given time interval is equal to the first time length.

In one embodiment, a length of the given time interval being related to the first time length comprises: a length of the given time interval is an integral multiple of the first time length.

In one embodiment, the given time interval comprises at least one DRX cycle.

In one embodiment, the given time interval comprises is a DRX cycle.

In one embodiment, the given time interval comprises is one or multiple DRX cycles.

In one embodiment, the given time interval comprises a positive integer number of DRX cycle(s).

In one embodiment, the given time interval comprises a continuous time interval.

In one embodiment, the given time interval comprises is a DRX cycle.

In one embodiment, the given time interval is for a DRX group, and the DRX group comprises at least one cell.

In one embodiment, the given time interval is for a cell.

In one embodiment, a length of the first time interval is unrelated to the first time length.

In one embodiment, a length of the first time interval is related to the first time length.

In one embodiment, a length of the first time interval is greater than the first time length.

In one embodiment, a length of the first time interval is not greater than the first time length.

In one embodiment, a length of the first time interval is less than the first time length.

In one embodiment, each time in the first time interval belongs to the given time interval.

In one embodiment, a length of the second time interval is not greater than the first time length.

In one embodiment, a length of the second time interval is less than the first time length.

In one embodiment, each time in the second time interval belongs to the given time interval.

In one embodiment, the first time length and the first offset are configured independently.

In one embodiment, the first time length and the first offset are configured jointly.

In one embodiment, the first time length is a candidate time length in the first candidate time length set; the first candidate time length set comprises multiple candidate time lengths.

In one subembodiment of the embodiment, the first candidate time length set comprises 20 candidate time lengths.

In one subembodiment of the embodiment, the first candidate time length set comprises 40 candidate time lengths.

In one subembodiment of the embodiment, each candidate time length in the first candidate time length set comprises a positive integer number of millisecond(s).

In one subembodiment of the embodiment, any two candidate time lengths in the first candidate time length set are not equal.

In one subembodiment of the embodiment, each candidate time length corresponds to multiple first-type offsets, and the first offset is one of the multiple first-type offsets.

In one embodiment, the first time length is configured through an RRC message.

In one embodiment, the first time length is configured through a MAC Control Element (CE).

In one embodiment, the first time length is configured through a DCI.

In one embodiment, the first time length comprises K1 ms(s), K1 being a positive integer, K1 being configurable.

In one embodiment, the first time length comprises K1 microsecond(s), K1 being a positive integer, K1 being configurable.

In one embodiment, the first time length comprises K1 subMilliSeconds(s), K1 being a positive integer, K1 being configurable.

In one embodiment, the first time length comprises K1 slot(s), K1 being a positive integer, K1 being configurable.

In one embodiment, a maximum value of K1 is equal to 10240.

In one embodiment, a maximum value of K1 is equal to 20240.

In one embodiment, a maximum value of K1 is configurable.

In one embodiment, a maximum value of K1 is fixed.

In one embodiment, the second time length is configured through an RRC message.

In one embodiment, the second time length is configured through a MAC CE.

In one embodiment, the second time length is configured through a DCI.

In one embodiment, the second time length comprises K2 ms(s), K2 being a positive integer, K2 being configurable.

In one embodiment, the second time length comprises K2 1/32 ms(s), K2 being a positive integer, K2 being configurable.

In one embodiment, the second time length comprises K2 microsecond(s), K2 being a positive integer, K2 being configurable.

In one embodiment, the second time length comprises K2 submicrosecond(s), K2 being a positive integer, K2 being configurable.

In one embodiment, the second time length comprises K2 slot(s), K2 being a positive integer, K2 being configurable.

In one embodiment, a length of the first time interval is equal to the second time length.

In one embodiment, a length of the first time interval is greater than the second time length.

In one embodiment, a length of the first time interval is less than the second time length.

In one embodiment, a length of the first time interval is related to at least the second time length.

In one embodiment, a length of the first time interval is related to the second time length and a third time length.

In one embodiment, the first offset is drx-StartOffset.

In one embodiment, a name of the first offset comprises at least one of drx-StartOffset or SDT or sdt or MT or mt.

In one embodiment, the first offset is drx-StartOffset-SDT.

In one embodiment, the first offset is configured through an RRC message.

In one embodiment, the first offset is configured through a MAC CE.

In one embodiment, the first offset is configured through a DCI.

In one embodiment, the first offset is equal to K3 ms(s), K3 being a non-negative integer, K3 being configurable.

In one embodiment, the first offset is equal to K3 microsecond(s), K3 being a non-negative integer, K3 being configurable.

In one embodiment, the first offset is equal to K3 submicrosecond(s), K3 being a non-negative integer, K3 being configurable.

In one embodiment, the first offset is equal to K3 slot(s), K3 being a non-negative integer, K3 being configurable.

In one embodiment, K3 is not greater than the K1.

In one embodiment, the second offset is drx-SlotOffset.

In one embodiment, a name of the second offset comprises at least one of drx-SlotOffset or SDT or sdt or MT or mt.

In one embodiment, the second offset is configurable.

In one embodiment, the second offset is configured through an RRC message.

In one embodiment, the second offset is configured through a MAC CE.

In one embodiment, the second offset is configured through a DCI.

In one embodiment, the second offset is equal to K4 1/32 ms, K4 being a positive integer, K4 being configurable.

In one embodiment, the second offset is equal to K4 1/16 ms, K4 being a positive integer, K4 being configurable.

In one embodiment, the second offset is equal to K4 ⅛ ms, K4 being a positive integer, K4 being configurable.

In one embodiment, the second offset is equal to K4 1/64 ms, K4 being a positive integer, K4 being configurable.

In one embodiment, the first node is configured with DCI with CRC scrambled by Power Saving (PS) (DCP)-RNTI monitoring.

In one embodiment, the first node is not configured with DCP monitoring.

In one embodiment, within the given time interval, the first node is constantly in RRC_INACTIVE state.

In one embodiment, within the given time interval, the first node is in the RRC_INACTIVE state, and the first node is in CM CONNECTED state.

In one embodiment, the RRC_INACTIVE state is RRC_INACTIVE state, and for the RRC_INACTIVE state, refer to 3GPP TS 38.300 or 3GPP TS 38.304 or 3GPP TS 38.331.

In one embodiment, the RRC_INACTIVE state is not RRC_CONNECTED state.

In one embodiment, within the given time interval, the first node executes cell reselection procedure.

In one embodiment, within the given time interval, the first node does not execute cell reselection procedure.

In one embodiment, within the given time interval, the first node does not execute cell reselection procedure.

In one embodiment, within the given time interval, the first node executes RAN-based Notification Area (RNA) update procedure.

In one embodiment, within the given time interval, the first node does not execute RNA update procedure.

In one embodiment, within the given time interval, the first node does not execute RNA update procedure.

In one embodiment, within the given time interval, the first node needs to monitor a paging channel (PCH) for RAN-initiated paging

In one embodiment, within the given time interval, the first node does not need to monitor a paging channel for an RAN-initiated paging.

In one embodiment, within the first time interval, the first node needs to monitor a paging channel for an RAN-initiated paging.

In one embodiment, within the first time interval, the first node does not need to monitor a paging channel for an RAN-initiated paging.

In one embodiment, within the second time interval, the first node needs to monitor a paging channel for an RAN-initiated paging.

In one embodiment, within the second time interval, the first node does not need to monitor a paging channel for an RAN-initiated paging.

In one embodiment, “the first node needs to monitor a paging channel for an RAN-initiated paging” comprises: the first node monitors a paging channel for an RAN-initiated paging through paging a DRX.

In one subembodiment of the above embodiment, the monitoring through paging a DRX refers to: discontinuous monitoring.

In one subembodiment of the above embodiment, the monitoring through paging a DRX refers to: monitoring in a paging occasion within a paging DRX cycle.

In one subembodiment of the above embodiment, the paging a DRX refers to a DRX for an RAN paging configured by Next Generation (NG)-RAN.

In one subembodiment of the above embodiment, the first node needs to monitor a paging channel for an RAN-initiated paging in a Paging Occasion (PO) within a paging DRX cycle for the first node.

In one embodiment, if the first node needs to monitor a paging channel for an RAN-initiated paging, the first node can receive a paging message.

In one embodiment, if the first node does not need to monitor a paging channel for an RAN-initiated paging, the first node does not receive a paging message.

In one embodiment, the “receiving a paging message” refers to: processing a paging message.

In one embodiment, the “receiving a paging message” refers to: if a DCI used for scheduling a paging message is received, a PDSCH scheduled by the DCI is processed, and the PDSCH carries at least the paging message.

In one embodiment, the paging message is a Paging message.

In one embodiment, the meaning of the processing comprises at least one of decoding or CRC check or de-multiplexing or delivering to the higher layer.

In one embodiment, the given time interval is a DRX cycle in a first DRX operation.

In one embodiment, the given time interval is a first DRX cycle in the first DRX operation.

In one embodiment, the given time interval is any DRX cycle in the first DRX operation.

In one embodiment, the given time interval is a long DRX cycle in the first DRX operation.

In one embodiment, the given time interval is a short DRX cycle in the first DRX operation.

In one embodiment, the first DRX operation corresponds to a DRX group, and the DRX group comprises at least one cell.

In one embodiment, the first DRX operation corresponds to a serving cell.

In one embodiment, the first DRX operation corresponds to the first cell.

In one embodiment, the first DRX operation is a DRX operation for the first RNTI in RRC_INACTIVE state.

In one embodiment, for the first DRX operation, a short DRX cycle is configured, and a long DRX cycle is used.

In one embodiment, for the first DRX operation, a short DRX cycle is configured, and a short DRX cycle is used.

In one embodiment, for the first DRX operation, a short DRX cycle is not configured, and a long DRX cycle is used.

In one embodiment, at least 3GPP R18 only supports configuring a long DRX period for the first RNTI in RRC_INACTIVE state.

In one embodiment, at least 3GPP R18 only supports configuring a long DRX period for the first RNTI in RRC_INACTIVE state and a short DRX period for the first RNTI in RRC_INACTIVE state.

In one embodiment, at least 3GPP R18 does not support configuring a short DRX period for the first RNTI in RRC_INACTIVE state.

In one embodiment, at least 3GPP R18 supports configuring a short DRX period for the first RNTI in RRC_INACTIVE state.

In one embodiment, the first time interval belongs to a DRX Active Time of the first DRX operation.

In one embodiment, the second time interval belongs to a DRX Inactive Time of the first DRX operation.

In one embodiment, the first node is not configured with a paging DRX operation.

In one embodiment, the first node is configured with a paging DRX operation.

In one subembodiment of the embodiment, the first DRX operation does not comprise a paging DRX operation.

In one subembodiment of the embodiment, the first DRX operation comprises a paging DRX operation.

In one subembodiment of the above embodiment, a paging DRX operation refers to: a PDCCH for a P-RNTI is discontinuously monitored.

In one subembodiment of the above embodiment, a paging DRX operation refers to: monitoring a paging channel for an RAN-initiated paging.

In one subembodiment of the embodiment, the first DRX operation and a paging DRX operation are configured independently.

In one subsidiary embodiment of the embodiment, a length of each DRX cycle of the first DRX operation is unrelated to a length of each DRX cycle of the paging DRX operation.

In one subsidiary embodiment of the embodiment, a beginning of each DRX cycle of the first DRX operation is unrelated to a beginning of a DRX cycle of the paging DRX operation.

In one subembodiment of the embodiment, the first DRX operation and the paging DRX operation are jointly configured.

In one subsidiary embodiment of the embodiment, a beginning of a DRX cycle of the first DRX operation is a beginning of a DRX cycle of the paging DRX operation.

In one subsidiary embodiment of the embodiment, a length of each DRX cycle of the paging DRX operation is a positive integral multiple of length(s) of each DRX cycle of the first DRX operation.

In one subembodiment of the embodiment, the first DRX operation and the paging DRX operation are exclusive in time domain.

In one subembodiment of the embodiment, during the first DRX operation is executed, the paging DRX operation is not executed.

In one subembodiment of the embodiment, within DRX active time and DRX inactive time of the first DRX operation, the paging DRX operation is not executed.

In one subembodiment of the embodiment, during the first DRX operation is executed, the paging DRX operation is executed.

In one subembodiment of the embodiment, within DRX inactive time of the first DRX operation, the paging DRX operation is executed.

In one subembodiment of the embodiment, as a response to the first MAC PDU being received, the paging DRX operation is executed.

In one embodiment, the first node is not configured with a DRX operation for MBS groupcast in the RRC_INACTIVE state.

In one embodiment, the first node is configured with a DRX operation for MBS groupcast in the RRC_INACTIVE state.

In one subembodiment of the embodiment, the first DRX operation does not comprise a DRX operation for MBS groupcast in the RRC_INACTIVE state.

In one subembodiment of the embodiment, the first DRX operation and a DRX operation for MBS groupcast in the RRC_INACTIVE state are configured independently.

In one subembodiment of the embodiment, the first DRX operation comprises a DRX operation for NIBS groupcast in the RRC_INACTIVE state.

In one subembodiment of the embodiment, a DRX operation for MBS groupcast in the RRC_INACTIVE state refers to: discontinuously monitoring a PDCCH for each G-RNTI or each G-CS-RNTI, and the each G-RNTI or each G-CS-RNTI is used for MBS groupcast.

In one embodiment, the first node is not configured with a DRX operation for MBS broadcast in the RRC_INACTIVE state.

In one embodiment, the first node is configured with a DRX operation for MBS broadcast in the RRC_INACTIVE state.

In one subembodiment of the embodiment, the first DRX operation does not comprise a DRX operation for MBS broadcast in the RRC_INACTIVE state.

In one subembodiment of the embodiment, the first DRX operation and a DRX operation for MBS broadcast in the RRC_INACTIVE state are configured independently.

In one subembodiment of the embodiment, the first DRX operation comprises a DRX operation for MBS broadcast in the RRC_INACTIVE state.

In one subembodiment of the embodiment, a DRX operation for MBS broadcast in the RRC_INACTIVE state refers to: a PDCCH for each G-RNTI is discontinuously monitored, and the each G-RNTI is used for MBS broadcast.

In one embodiment, the first node is not configured with any of a paging DRX operation, a DRX operation for MBS groupcast in the RRC_INACTIVE state, and a DRX operation for MBS broadcast in the RRC_INACTIVE state.

In one embodiment, the first node is configured with any of a paging DRX operation, a DRX operation for MBS groupcast in the RRC_INACTIVE state, and a DRX operation for MB S broadcast in the RRC_INACTIVE state.

In one embodiment, the first DRX operation is executed when the first node is in the RRC_INACTIVE state.

In one embodiment, within each DRX cycle of the first DRX operation, the first node is in the RRC_INACTIVE state.

### Embodiment 2

Embodiment 2 illustrates a schematic diagram of a network architecture according to one embodiment of the present application, as shown in FIG. 2. FIG. 2 is a diagram illustrating a network architecture 200 of 5G NR/Long-Term Evolution (LTE)/Long-Term Evolution Advanced (LTE-A) systems. The 5G NR/LTE/LTE-A network architecture 200 may be called a 5G System (5GS)/Evolved Packet System (EPS) 200 or other appropriate terms. The 200 comprises at least one of a UE 201, an RAN 202, a 5G Core Network/Evolved Packet Core (5GC/EPC) 210, a Home Subscriber Server (HSS)/Unified Data Management (UDM) 220 or an Internet Service 230. The 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The RAN comprises the node 203 and other nodes 204. The node 203 provides UE 201-oriented user plane and control plane protocol terminations. The node 203 may be connected to other nodes 204 via an Xn interface (e. g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a UE.

In one embodiment, the node 203 is a relay.

In one embodiment, the node 203 is a gateway.

In one embodiment, the node 204 corresponds to the third node in the present application.

In one embodiment, the node 204 is a base station.

In one embodiment, the node 204 is a UE.

In one embodiment, the node 204 is a relay.

In one embodiment, the node 204 is a gateway.

In one embodiment, the node 203 and the node 204 are in connection via an ideal backhaul.

In one embodiment, the node 203 and the node 204 are in connection via a non-ideal backhaul.

In one embodiment, the node 203 and the node 204 provide radio resources for the UE 201 at the same time.

In one embodiment, the node 203 and the node 204 do not provide radio resources for the UE 201 at the same time.

In one embodiment, the node 203 and the node 204 are a same node.

In one embodiment, the node 203 and the node 204 are two different nodes.

In one embodiment, types of the node 203 and the node 204 are the same.

In one embodiment, types of the node 203 and the node 204 are different.

In one embodiment, the UE supports Terrestrial Network (NTN) transmission.

In one embodiment, the UE supports Non-Terrestrial Network (NTN) transmission.

In one embodiment, the UE supports transmission within networks with large latency difference.

In one embodiment, the UE supports Dual Connection (DC) transmission.

In one embodiment, the UE comprises an aircraft.

In one embodiment, the UE comprises a vehicle terminal.

In one embodiment, the UE comprises a vessel.

In one embodiment, the UE comprises an Internet of Things (IoT) terminal.

In one embodiment, the UE comprises an industrial IoT terminal.

In one embodiment, the UE comprises a device supporting transmission with low-latency and high-reliability.

In one embodiment, the UE comprises test equipment.

In one embodiment, the UE comprises a signaling tester.

In one embodiment, the base station comprises a Base Transceiver Station (BTS).

In one embodiment, the base station comprises NodeB (NB).

In one embodiment, the base station comprises gNB.

In one embodiment, the base station comprises eNB.

In one embodiment, the base station comprises ng-eNB.

In one embodiment, the base station comprises en-gNB.

In one embodiment, the base station supports transmission within non-terrestrial networks.

In one embodiment, the base station supports transmission within networks with large latency difference.

In one embodiment, the base station supports transmission within terrestrial networks.

In one embodiment, the base station comprises a Marco Cellular base station.

In one embodiment, the base station comprises a Micro Cell base station.

In one embodiment, the base station comprises a Pico Cell base station.

In one embodiment, the base station comprises a Femtocell.

In one embodiment, the base station comprises a base station supporting large latency differences.

In one embodiment, the base station comprises flight platform equipment.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling tester.

In one embodiment, the base station comprises an Integrated Access and Backhaul (IAB)-node.

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises an L3 relay.

In one embodiment, the relay comprises an L2 relay.

In one embodiment, the relay comprises a router.

In one embodiment, the relay comprises a switcher.

In one embodiment, the relay comprises a UE.

In one embodiment, the relay comprises a base station.

### Embodiment 3

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 is represented by three layers, which are a layer 1, a layer 2 and a layer 3, respectively. The layer 1 (L1) is the lowest layer and performs signal processing functions of various PHY layers. The L1 is called PHY 301 in the present application. L2 305, above the PHY 301, comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a data packet and provides support for handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resources block) in a cell. The MAC sublayer 302 is also in charge of HARQ operation. The RRC sublayer 306 in L3 layer of the control plane 300 is responsible for acquiring radio resources (i.e., radio bearer) and configuring the lower layer with an RRC signaling. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic.

In one embodiment, the radio protocol architecture in FIG. 3 is applicable to the first node in the present application.

In one embodiment, the radio protocol architecture in FIG. 3 is applicable to the second node in the present application.

In one embodiment, the first DCI in the present application is generated by the PHY 301 or the PHY 351.

In one embodiment, the first MAC PDU in the present application is generated by the RRC 306.

In one embodiment, the first MAC PDU in the present application is generated by the MAC 302 or the MAC 352.

In one embodiment, the first message in the present application is generated by the RRC 306.

In one embodiment, the first message in the present application is generated by the MAC 302 or the MAC 352.

In one embodiment, the first message in the present application is generated by the PHY 301 or the PHY 351.

In one embodiment, the second message in the present application is generated by the RRC 306.

In one embodiment, the second message in the present application is generated by the MAC 302 or the MAC 352.

In one embodiment, the second message in the present application is generated by the PHY 301 or the PHY 351.

In one embodiment, the third message in the present application is generated by the RRC 306.

In one embodiment, the third message in the present application is generated by the MAC 302 or the MAC 352.

In one embodiment, the third message in the present application is generated by the PHY 301 or the PHY 351.

### Embodiment 4

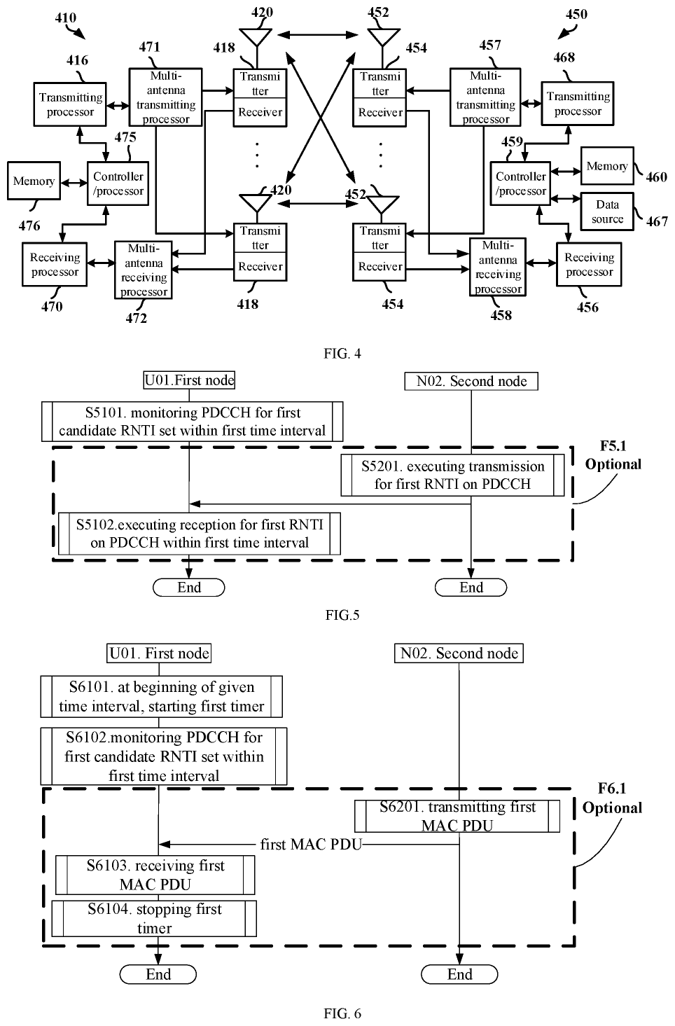

Embodiment 4 illustrates a schematic diagram of a first communication device and a second communication device in the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, herein, the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises at least one processor and at least one memory. at least one processor and at least one memory. The at least one memory comprises computer program codes; the at least one memory and the computer program codes are configured to be used in collaboration with the at least one processor, the first communication device 450 at least: monitors a PDCCH for a first candidate RNTI set within a first time interval, the first candidate RNTI set comprises at least one first RNTI, and the first RNTI is not a P-RNTI; herein, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the first communication device 450 comprises at least one processor and at least one memory. a memory that stores a computer readable instruction program. The computer readable instruction program generates an action when executed by at least one processor. The action includes: monitoring a PDCCH for a first candidate RNTI set within a first time interval, the first candidate RNTI set comprising at least a first RNTI, the first RNTI not being a P-RNTI; herein, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: executes a transmission for a first RNTI on a PDCCH, the first RNTI is not a P-RNTI; herein, a node identified by the first RNTI monitors a PDCCH for a first candidate RNTI set within a first time interval, and the first candidate RNTI set comprises at least the first RNTI; within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the second communication device 410 comprises a memory that stores a computer readable instruction program. The computer readable instruction program generates an action when executed by at least one processor. The action includes: executing a transmission for a first RNTI on a PDCCH, the first RNTI not being a P-RNTI; herein, a node identified by the first RNTI monitors a PDCCH for a first candidate RNTI set within a first time interval, and the first candidate RNTI set comprises at least the first RNTI; within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the antenna 452, the receiver 454, the receiving processor 456, and the controller/processor 459 are used to monitor a PDCCH for a first RNTI.

In one embodiment, at least one of the antenna 420, the transmitter 418, the transmitting processor 416, or the controller/processor 475 is used to execute a transmission for a first RNTI on a PDCCH.

In one embodiment, the antenna 452, the receiver 454, the receiving processor 456, and the controller/processor 459 are used to receive a first DCI.

In one embodiment, at least one of the antenna 420, the transmitter 418, the transmitting processor 416, or the controller/processor 475 is used to transmit a first DCI.

In one embodiment, the antenna 452, the receiver 454, the receiving processor 456, and the controller/processor 459 are used to receive a first MAC PDU.

In one embodiment, at least one of the antenna 420, the transmitter 418, the transmitting processor 416, or the controller/processor 475 is used to transmit a first MAC PDU.

In one embodiment, the antenna 452, the receiver 454, the receiving processor 456, and the controller/processor 459 are used to receive a first message.

In one embodiment, at least one of the antenna 420, the transmitter 418, the transmitting processor 416, or the controller/processor 475 is used to transmit a first message.

In one embodiment, the antenna 452, the transmitter 454, the transmitting processor 468, and the controller/processor 459 are used to transmit a second message.

In one embodiment, at least one of the antenna 420, the receiver 418, the receiving processor 470, or the controller/processor 475 is used to receive a second message.

In one embodiment, the antenna 452, the receiver 454, the receiving processor 456, and the controller/processor 459 are used to receive a third message.

In one embodiment, at least one of the antenna 420, the transmitter 418, the transmitting processor 416, or the controller/processor 475 is used to transmit a third message.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a UE that supports large delay difference.

In one embodiment, the first communication device 450 is a UE that supports NTN.

In one embodiment, the first communication device 450 is an aircraft device.

In one embodiment, the first communication device 450 has a positioning capability.

In one embodiment, the first communication device 450 does not have a positioning capability.

In one embodiment, the first communication device 450 is a UE that supports TN.

In one embodiment, the second communication device 410 is a base station (gNB/eNB/ng-eNB).

In one embodiment, the second communication device 410 is a base station that supports large delay differences.

In one embodiment, the second communication device 410 is a base station that supports NTN.

In one embodiment, the second communication device 410 is satellite equipment.

In one embodiment, the second communication device 410 is flying platform equipment.

In one embodiment, the second communication device 410 is a base station that supports TN.

### Embodiment 5

Embodiment 5 illustrates a flowchart of radio signal transmission according to one embodiment in the present application, as shown in FIG. 5. It is particularly underlined that the order illustrated in the embodiment does not put constraints over sequences of signal transmissions and implementations.

The first node U01 monitors a PDCCH for a first candidate RNTI set within a first time interval in step S5101, the first candidate RNTI set comprises at least a first RNTI, and the first RNTI is not a P-RNTI; in step S5102, executes a reception for the first RNTI on the PDCCH.

The second node N02 in step S5201 executes a transmission for the first RNTI on the PDCCH.

In embodiment 5, the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node U01 is in RRC_INACTIVE state.

In one embodiment, the first node U01 is a UE.

In one embodiment, the first node U01 is a base station.

In one embodiment, the first node U01 is a relay.

In one embodiment, the second node N02 is a base station.

In one embodiment, the second node N02 is a UE.

In one embodiment, the second node N02 is a relay.

In one embodiment, the second node is a maintenance base station of the first cell.

Typically, the first node U01 is a UE, and the second node N02 is a gNB.

In one embodiment, the second node determines a time for transmitting the first RNTI.

In one embodiment, the second node determines a time for transmitting the first RNTI according to at least one of the given time interval, the first time interval or the second time interval.

In one embodiment, the second node determines a time for transmitting the first RNTI, so as to ensure that the second node executes a reception for the first RNTI on the PDCCH within the first time interval.

In one embodiment, within the first time interval, a reception on the first RNTI is executed on the PDCCH.

In one embodiment, within the first time interval, if a transmission for the first RNTI is detected, a reception on the first RNTI is executed on the PDCCH.

In one embodiment, within the first time interval, if a transmission for the first RNTI is not detected, a reception on the first RNTI is not executed on the PDCCH.

In one embodiment, a transmission for the first RNTI is a DCI, and the DCI is scrambled by the first RNTI.

In one subembodiment of the embodiment, a format of the DCI is DCI format 1_0.

In one subembodiment of the embodiment, a format of the DCI is DCI format 1_1.

In one subembodiment of the embodiment, a format of the DCI is DCI format 1_2.

In one subembodiment of the embodiment, a format of the DCI is DCI format 4_0.

In one subembodiment of the embodiment, a format of the DCI is DCI format 4_1.

In one subembodiment of the embodiment, a format of the DCI is DCI format 4_2.

In one embodiment, a transmission for the first RNTI is a physical-layer signaling, and the physical-layer signaling is identified by the first RNTI.

In one embodiment, a transmission for the first RNTI is a downlink signaling, and the downlink signaling is identified by the first RNTI.

In one embodiment, the dotted box F5.1 is optional.

In one embodiment, the dotted box F5.1 exists.

In one embodiment, the dotted box F5.1 does not exist.

In one embodiment, if the dotted box F5.1 exists, a reception for the first RNTI is executed on the PDCCH.

In one embodiment, if the dotted box F5.1 exists, a transmission for the first RNTI is detected on the PDCCH.

In one embodiment, if the dotted box F5.1 does not exist, a reception for the first RNTI is not executed on the PDCCH.

In one embodiment, if the dotted box F5.1 does not exist, a transmission for the first RNTI is not detected on the PDCCH.

### Embodiment 6

Embodiment 6 illustrates a flowchart of radio signal transmission according to another embodiment of the present application, as shown in FIG. 6. It is particularly underlined that the order illustrated in the embodiment does not put constraints over sequences of signal transmissions and implementations.

The first node U01 in step S6101, at a beginning of the given time interval, starts a first timer; in step S6102, monitors a PDCCH for a first candidate RNTI set within a first time interval, the first candidate RNTI set comprises at least a first RNTI, the first RNTI is not a P-RNTI; in step S6103, receives a first MAC PDU; in step S6104, as a response to the first MAC PDU being correctly received, stops the first timer.

The second node N02 transmits the first MAC PDU in step S6201.

In embodiment 6, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node U01 is in RRC_INACTIVE state; the second time length is used to determine a running time of the first timer; the first MAC PDU comprises at least a first MAC SDU; the first MAC PDU does not comprise a MAC subheader with an LCID field set to 59 or 60.

In one embodiment, the first MAC PDU set comprises at least one MAC subPDU.

In one embodiment, the first MAC PDU is received at air interface.

In one embodiment, the first MAC PDU is received on downlink.

In one embodiment, the “receiving a first MAC PDU” comprises: receiving a PDSCH, the PDSCH carrying the first MAC PDU.

In one embodiment, the “receiving a first MAC PDU” comprises: receiving a Transmission Block (TB), and data in the TB comprising the first MAC PDU.

In one embodiment, the “receiving a first MAC PDU” comprises: receiving and decoding a TB, and data in the TB comprising the first MAC PDU.

In one embodiment, the phrase of as a response to the first MAC PDU being correctly received comprises: at a time when data which the MAC entity attempted to decode was successfully decoded for a TB, or, an M1-th time unit after the data which the MAC entity attempted to decode was successfully decoded for the TB, and data in the TB comprising the first MAC PDU.

In one embodiment, the phrase of as a response to the first MAC PDU being correctly received comprises: at a time when data which the MAC entity attempted to decode was successfully decoded for a TB, and this is the time when or after the first successful decoding of the data for the TB, and data in the TB comprising the first MAC PDU.

In one embodiment, the phrase of as a response to the first MAC PDU being correctly received comprises: at a time when a decoded MAC PDU is delivered to a disassembly and demultiplexing entity, or an M1-th time unit after a decoded MAC PDU is delivered to a disassembly and demultiplexing entity, and the decoded MAC PDU being the first MAC PDU.

In one embodiment, the phrase of as a response to the first MAC PDU being correctly received comprises: at a time when the first MAC PDU is disassembled and de-multiplexed to obtain the first MAC SDU, or an M1-th time unit after the first MAC PDU is disassembled and de-multiplexed to obtain the first MAC SDU.

In one embodiment, the phrase of as a response to the first MAC PDU being correctly received comprises: at a time when the first MAC SDU in the first MAC PDU is received, or an M1-th time unit after the first MAC SDU in the first MAC PDU is received.

In one embodiment, the phrase of as a response to the first MAC PDU being correctly received comprises: at a time for instructing the physical layer to generate acknowledgement(s) of the data in a TB, or an M1-th time unit after instructing the physical layer to generate acknowledgement(s) of the data in the TB, and data in the TB comprising the first MAC PDU.

In one embodiment, the phrase of as a response to the first MAC PDU being correctly received comprises: at a time when the physical layer transmits acknowledgement(s) of data in a TB, or an M1-th time unit after the physical layer transmits acknowledgement(s) of data in the TB, and the data in the TB comprising the first MAC PDU.

In one embodiment, M1 is predefined.

In one embodiment, M1 is configurable.

In one embodiment, M1 is pre-configured.

In one embodiment, M1 is a positive integer.

In one embodiment, the M1 is variable.

In one embodiment, M1 is fixed.

In one embodiment, the time unit is ms.

In one embodiment, the time unit is slot.

In one embodiment, the time unit is symbol.

In one embodiment, the time unit is an Orthogonal frequency division multiplex (OFDM) symbol.

In one embodiment, within the given time interval, each time the first time length passes, the first timer is started.

In one embodiment, the first timer is a drx-onDurationTimer.

In one embodiment, a name of the first timer comprises at least one of drx-onDurationTimer or SDT or sdt or MT or mt.

In one embodiment, the first timer is a drx-onDurationTimerSDT.

In one embodiment, the “stopping the first time?” refers to: the first timer does not continue to run.

In one embodiment, the “stopping the first timer” refers to: enabling the first timer not running.

In one embodiment, a time when the first timer is stopped is an end time of the first time interval, and a time when the first timer is stopped is a beginning of the second time interval.

In one embodiment, after the first timer is stopped, the first timer is not in running state.

In one embodiment, within the second time interval, the first timer is not running.

In one embodiment, the first time interval comprises a time interval when the first timer is running.

In one embodiment, the first MAC SDU is a MAC SDU.

In one embodiment, the first MAC SDU is a Dedicated Traffic Channel (DTCH) SDU.

In one embodiment, the first MAC SDU is a Dedicated Control Channel (DCCH) SDU.

In one embodiment, the first MAC SDU is a MBS Traffic Channel (MTCH) SDU.

In one embodiment, the first MAC SDU is a MBS Control Channel (MCCH) SDU.

In one embodiment, a MAC subPDU in the first MAC PDU comprises the first MAC SDU.

In one embodiment, the first MAC PDU only comprises the first MAC SDU and a MAC subheader corresponding to the first MAC SDU.

In one embodiment, the first MAC PDU only comprises a MAC subPDU to which the first MAC SDU belongs.

In one embodiment, the first MAC PDU only comprises a MAC subPDU to which the first MAC SDU belongs and padding.

In one embodiment, the first MAC PDU comprises the first MAC SDU and at least one MAC subPDU, any MAC subPDU in the at least one MAC subPDU does not comprise the first MAC SDU.

In one embodiment, a MAC subheader with an LCID field set to 59 indicates a DRX Command MAC CE.

In one embodiment, a MAC subheader with an LCID field set to 59 indicates a Long DRX Command MAC CE.

In one embodiment, the phrase that the first MAC PDU does not comprise a MAC subheader with an LCID field set to 59 or 60 comprises: the first MAC PDU does not comprise a DRX Command MAC CE.

In one embodiment, the phrase that the first MAC PDU does not comprise a MAC subheader with an LCID field set to 59 or 60 comprises: the first MAC PDU does not comprise a Long DRX Command MAC CE.

In one embodiment, the phrase that the first MAC PDU does not comprise a MAC subheader with an LCID field set to 59 or 60 comprises: the first MAC PDU does not comprise a DRX Command MAC CE, and the first MAC PDU does not comprise a Long DRX Command MAC CE.

In one embodiment, the dotted box F6.1 is optional.

In one embodiment, the dotted box F6.1 exists.

In one embodiment, the dotted box F6.1 does not exist.

In one embodiment, a part in the dotted box F6.1 does not exist.

In one embodiment, the first timer is stopped.

In one embodiment, the first timer is not stopped.

In one embodiment, the first MAC PDU is not used to trigger stopping the first timer.

### Embodiment 7

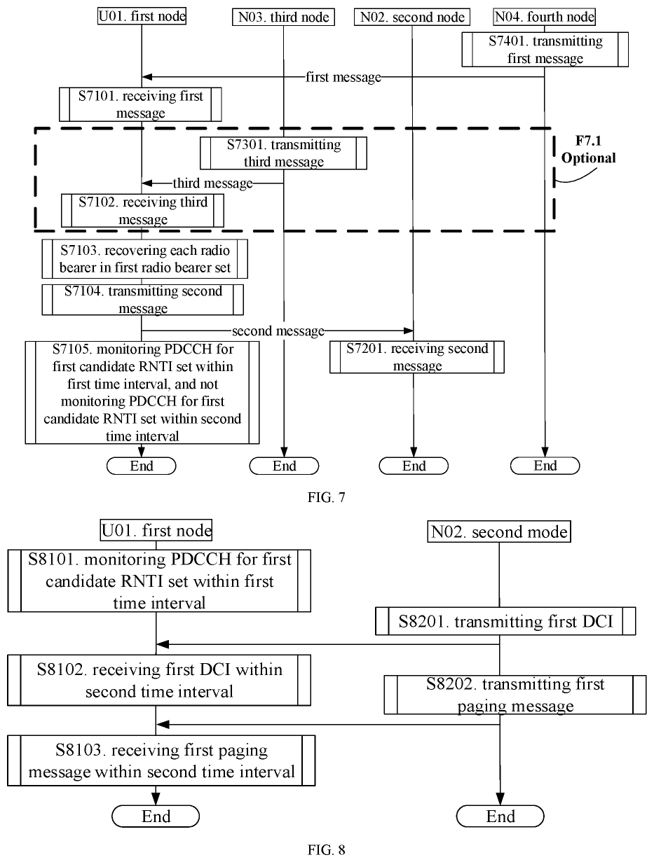

Embodiment 7 illustrates a flowchart of radio signal transmission according to another embodiment in the present application, as shown in FIG. 7. It is particularly underlined that the order illustrated in the embodiment does not put constraints over sequences of signal transmissions and implementations.

The first node U01 in step S7101, receives a first message, the first message indicates that the first node U01 enters into or maintains the RRC_INACTIVE state; in step S7102, receives a third message in the RRC_INACTIVE state, the third message indicates that the first node U01 performs a data transmission in the RRC_INACTIVE state; in step S7103, accompanying the second message, recovers each radio bearer in a first radio bearer set; in step S7104, transmits a second message in the RRC_INACTIVE state, the second message is used to initiate a data transmission procedure in the RRC_INACTIVE state; in step S7105, monitors a PDCCH for a first candidate RNTI set within a first time interval, the first candidate RNTI set comprises at least one first RNTI, the first RNTI is not a P-RNTI, and within a second time interval, a PDCCH for the first candidate RNTI set is not monitored.

The second node N02 receives the second message in step S7201.

The third node N03 transmits the third message in step S7301.

The fourth node N04 transmits the first message in step S7401.

In embodiment 7, the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node U01 is in RRC_INACTIVE state; the first message is an RRC message; within a time interval from a time when the first message is received to a beginning of the given time interval, the first node U01 does not receive any RRC message indicating that the first node U01 enters into or maintains the RRC_INACTIVE state; the first radio bearer set comprises at least one radio bearer, and the first radio bearer set does not comprise SRB1; data transmission procedure in the RRC_INACTIVE state is used to determine monitoring a PDCCH for a first candidate RNTI set; the third message is used to trigger the second message.

In one embodiment, the third node N03 is a base station.

In one embodiment, the third node N03 is a UE.

In one embodiment, the third node N03 is a relay.

In one embodiment, the fourth node N04 is a base station.

In one embodiment, the fourth node N04 is a UE.

In one embodiment, the fourth node N04 is a relay.

Typically, the first node U01 is a UE, and the second node N02 is a gNB, the third node N03 is a gNB, and the fourth node N04 is a gNB.

In one embodiment, the second node N02, the third node N03 and the fourth node N04 are the same.

In one embodiment, there at least exist two of the second node N02, the third node N03 and the fourth node N04 being different.

In one embodiment, the third node N03 is the second node N02.

In one embodiment, the third node N03 is not the second node N02.

In one embodiment, the third node N03 is the fourth node N02.

In one embodiment, the third node N03 is not the fourth node N02.

In one embodiment, higher layer of the RRC layer of the first node requesting recovering an RRC

connection is used to trigger the second message.

In one embodiment, as a response to the first message being received, suspend all Signalling Radio Bearers (SRBs) other than Signalling Radio Bearer 0 (SRB0), suspend all DRBs, and suspend all multicast MBS Radio Bearers (MRBs).

In one embodiment, as a response to the first message being received, indicate Packet Data Convergence Protocol (PDCP) suspend to lower layers of all DRBs.

In one embodiment, the first message is received in the RRC_INACTIVE state.

In one embodiment, the first message is received in RRC_CONNECTED state.

In one embodiment, the first message is received through SRB1.

In one embodiment, the first message is transmitted on a Dedicated Control Channel (DCCH).

In one embodiment, the first information comprises at least one RRC Information Element (IE).

In one embodiment, the first message comprises at least one RRC field.

In one embodiment, the first message is an RRCRelease message.

In one embodiment, before the first message is received, and if the first message is in RRC_CONNECTED state, the first message is used to determine entering into the RRC_INACTIVE state.

In one embodiment, before the first message is received, and if the first message is in RRC_INACTIVE state, the first message is used to determine maintaining the RRC_INACTIVE state.

In one embodiment, as a response to the first message being received, enter into the RRC_INACTIVE state.

In one embodiment, as a response to the first message being received, maintain the RRC_INACTIVE state.

In one embodiment, as a response to the first message being received, the first node U01 is in the RRC_INACTIVE state.

In one embodiment, the first message indicates that the first node U01 enters into or maintains the RRC_INACTIVE state.

In one embodiment, the first message comprises a target RRC field, and the first message comprising the target RRC field is used to indicate that the first node U01 enters into or maintains the RRC_INACTIVE state.

In one embodiment, the first message comprising a target RRC field is used to determine entering into or maintaining the RRC_INACTIVE state.

In one embodiment, if the first message comprises a target RRC field, the first node U01 is indicated entering into or maintaining the RRC_INACTIVE state.

In one embodiment, the target RRC field comprises a suspendConfig field.

In one embodiment, the target RRC field is a suspendConfig field.

In one embodiment, the target RRC field is a suspendConfig1 field.

In one embodiment, the target RRC field is a suspendConfig2 field.

In one embodiment, the target RRC field comprises at least one RRC field.

In one embodiment, the target RRC field comprises at least one RRC IE.

In one embodiment, the target RRC field belongs to the first message.

In one embodiment, the target RRC field is all or part of the first message.

In one embodiment, the target RRC field is an RRC field in the first message.

In one embodiment, an RRC message indicating that the first node enters into or maintains the RRC_INACTIVE state refers to an RRCRelease message.

In one embodiment, an RRC message indicating that the first node enters into or maintains the RRC_INACTIVE state refers to an RRCRelease message, and the RRCRelease message comprises a suspendConfig field.

In one embodiment, the second message is triggered in the RRC_INACTIVE state, and the second message is transmitted in the RRC_INACTIVE state.

In one embodiment, the phrase that the second message is used to initiate data transmission procedure in the RRC_INACTIVE state comprises: the second message is used to request a data transmission in the RRC_INACTIVE state.

In one embodiment, the phrase that the second message is used to initiate data transmission procedure in the RRC_INACTIVE state comprises: the second message is used to request recovering an RRC connection, and a cause for requesting recovering an RRC connection is performing data transmission in the RRC_INACTIVE state.

In one embodiment, data transmission procedure in the RRC_INACTIVE state refers to: uplink data transmission in the RRC_INACTIVE state.

In one embodiment, data transmission procedure in the RRC_INACTIVE state refers to: downlink data transmission in the RRC_INACTIVE state.

In one embodiment, data transmission procedure in the RRC_INACTIVE state refers to: unicast-based downlink data transmission in the RRC_INACTIVE state.

In one embodiment, data transmission procedure in the RRC_INACTIVE state refers to: multicast-based downlink data transmission in the RRC_INACTIVE state.

In one embodiment, data transmission procedure in the RRC_INACTIVE state refers to: MT-SDT.

In one embodiment, data transmission procedure in the RRC_INACTIVE state refers to: MO-SDT.

In one embodiment, data transmission procedure in the RRC_INACTIVE state refers to: receiving multicast MBS in the RRC_INACTIVE state.

In one embodiment, data transmission procedure in the RRC_INACTIVE state refers to: using the first radio bearer set for a data transmission in the RRC_INACTIVE state.

In one embodiment, each candidate RNTI in the first candidate RNTI set is used for data transmission procedure in the RRC_INACTIVE state.

In one embodiment, each candidate RNTI in the first candidate RNTI set is used for MT-SDT.

In one embodiment, each candidate RNTI in the first candidate RNTI set is used for MO-SDT.

In one embodiment, if data transmission procedure in the RRC_INACTIVE state comprises MT-SDT, the first candidate RNTI set comprises at least one of a C-RNTI or a CS-RNTI.

In one embodiment, if data transmission procedure in the RRC_INACTIVE state comprises MO-SDT, the first candidate RNTI set comprises at least one of a C-RNTI or a CS-RNTI.

In one embodiment, each candidate RNTI in the first candidate RNTI set is used for receiving an MBS in the RRC_INACTIVE state.

In one embodiment, if data transmission procedure in the RRC_INACTIVE state comprises receiving an MBS in the RRC_INACTIVE state, the first candidate RNTI set comprises at least one of a G-RNTI or a G-CS-RNTI.

In one embodiment, the second message is delivered by an RRC layer of the first node U01 to a lower layer of the RRC layer of the first node U01.

In one embodiment, as a response to the second message being delivered by an RRC layer of the first node U01 to the lower layer of the RRC layer of the first node U01, a MAC SDU corresponding to the second message is transmitted through message 3 or message A in a random access procedure.

In one subembodiment of the above embodiment, preamble resources in the random access procedure indicate an SDT.

In one subembodiment of the above embodiment, preamble resources in the random access procedure do not indicate an SDT.

In one subembodiment of the above embodiment, preamble resources in the random access procedure are SDT-specific preamble resources.

In one subembodiment of the above embodiment, preamble resources in the random access procedure are not SDT-specific preamble resources.

In one embodiment, as a response to the second message being delivered by an RRC layer of the first node U01 to the lower layer of the RRC layer of the first node UOL a MAC SDU corresponding to the second message is transmitted through CG resources of a CG-SDT procedure.

In one embodiment, the lower layer of the RRC layer comprises at least one of a PDCP layer or an RLC layer or an MAC layer or a PHY layer.

In one embodiment, before the second message is delivered by an RRC layer of the first node U01 to a lower layer of the RRC layer of the first node U01, set contents in the second message.

In one embodiment, the second message comprises at least the RRC connection resume request message.

In one embodiment, the second message is the RRC connection resume request message.

In one embodiment, the second message is an RRC message.

In one embodiment, the second message comprises at least RRC message.

In one embodiment, the second message comprises at least one RRC IE.

In one embodiment, the second message comprises at least one RRC field.

In one embodiment, the second message is transmitted through a Common Control Channel (CCCH), and the RRC connection resume request message is an RRCResumeRequest message.

In one embodiment, the second message is transmitted through Common Control Channel 1 (CCCH1), and the RRC connection resume request message is RRCResumeRequest1 message.

In one embodiment, the second message is transmitted through a Common Control Channel 2 (CCCH2), and the RRC connection resume request message is RRCResumeRequest2 message.

In one embodiment, the second message is transmitted through a Signalling Radio Bearer0 (SRB0).

In one embodiment, the second message comprises a resumeIdentity field, and the resumeIdentity field is set as a bit string.

In one embodiment, the above bit string is a shortI-RNTI of the first node U01.

In one embodiment, the above bit string is a fullI-RNTI of the first node U01.

In one embodiment, the above bit string comprises 24 bits.

In one embodiment, the above bit string comprises 40 bits.

In one embodiment, the second message comprises a resumeMAC-I field, and the resumeMAC-I field is set as a bit string.

In one embodiment, the second message comprises a resumeCause field.

In one embodiment, the “accompanying the second message” refers to: before the second message is delivered by an RRC layer of the first node U01 to a lower layer of the RRC layer of the first node U01.

In one embodiment, the “accompanying the second message” refers to: after contents in the second message are set, and before the second message is delivered to a lower layer of RRC layer.

In one embodiment, the “accompanying the second message” refers to: before the second message is transmitted.

In one embodiment, the “accompanying the second message” refers to: before the second message is transmitted at MAC layer.

In one embodiment, the “accompanying the second message” refers to: upon the second message is transmitted at MAC layer.

In one embodiment, the “accompanying the second message” refers to: at least before a confirmation message for the second message is received.

In one embodiment, the “accompanying the second message” refers to: a time when the second message is delivered to a lower layer of the RRC layer passes a time interval.

In one embodiment, the “accompanying the second message” refers to: when a lower layer of an RRC layer transmits the second message for a first time.

In one embodiment, the “recovering each radio bearer in a first radio bearer set” comprises: resuming all radio bearers in the first radio bearer set.

In one embodiment, the “recovering each radio bearer in a first radio bearer set” comprises: if the first radio bearer set comprises at least one DRB, recovering the at least one DRB.

In one embodiment, the “recovering each radio bearer in a first radio bearer set” comprises: if the first radio bearer set comprises SRB2, recovering the SRB2.

In one embodiment, accompanying the second message, resume SRB1.

In one embodiment, accompanying the second message, a radio bearer suspended other than the SRB1, SRB0 and the first radio bearer set is not recovered.

In one embodiment, the first radio bearer set comprises only one radio bearer.

In one embodiment, the first radio bearer set comprises one or multiple radio bearers.

In one embodiment, a number of radio bearer(s) comprised in the first radio bearer set is configurable.

In one embodiment, type(s) of radio bearer(s) comprised in the first radio bearer set is(are) configurable.

In one embodiment, the first radio bearer set does not comprise SRB0.

In one embodiment, the first radio bearer set does not comprise a multicast MRB.

In one embodiment, the first radio bearer set comprises a multicast MRB.

In one embodiment, the first radio bearer set does not comprise Signalling Radio Bearer 2 (SRB2).

In one embodiment, the first radio bearer set comprises SRB2.

In one embodiment, the first radio bearer set comprises at least one of SRB2 or a DRB.

In one embodiment, any radio bearer in the first radio set is a DRB or SRB2.

In one embodiment, if data transmission procedure in the RRC_INACTIVE state comprises an MO-SDT, the first candidate RNTI set comprises at least one of a DRB or SRB2.

In one embodiment, if data transmission procedure in the RRC_INACTIVE state comprises an MT-SDT, the first candidate RNTI set comprises at least one of a DRB or SRB2.

In one embodiment, if data transmission procedure in the RRC_INACTIVE state comprises receiving an MBS in the RRC_INACTIVE state, the first candidate RNTI set comprises at least one of a multicast MRB or SRB2.

In one embodiment, if a MAC SDU corresponding to the second message is transmitted through message 3 or message A in a random access procedure, a random access procedure being successfully completed is used to determine monitoring a PDCCH for a first candidate RNTI set.

In one embodiment, if a MAC SDU corresponding to the second message is transmitted through CG resources of a CG-SDT procedure, an initial transmission of a CG-SDT procedure being successfully completed is used to determine monitoring a PDCCH for a first candidate RNTI set.

In one embodiment, if a data transmission procedure in RRC_INACTIVE state is executed, and the first node is configured with the first DRX operation for data transmission procedure in the RRC_INACTIVE state, monitor a PDCCH for a first candidate RNTI set according to the first DRX operation.

In one embodiment, the third message explicitly indicates that the first node U01 performs data transmission in the RRC_INACTIVE state.

In one embodiment, the third message implicitly indicates that the first node U01 performs data transmission in the RRC_INACTIVE state.

In one embodiment, the third message is transmitted through a Paging Control Channel (PCCH).

In one embodiment, the third message is used for paging.

In one embodiment, the third message is used for RAN paging.

In one embodiment, the third message is triggered by NG-RAN.

In one embodiment, the third message is a Paging Message.

In one embodiment, the third message is at least one field in a paging message.

In one embodiment, the third message is at least one IE in a paging message.

In one embodiment, the third message comprises an RRC message.

In one embodiment, the third message is a radio message.

In one embodiment, the third message is a downlink message.

In one embodiment, the third message is an RRC message.

In one embodiment, the third message is a paging message.

In one embodiment, the third message is a Paging message.

In one embodiment, the third message comprises at least one RRC IE.

In one embodiment, the third message comprises at least one RRC field.

In one embodiment, the third message comprises an RRC field whose name comprises Paging, Record, or List.

In one embodiment, the third message comprises a PagingRecordList.

In one embodiment, the third message comprises at least one PagingRecord field.

In one embodiment, the third message is a PagingRecord field.

In one embodiment, the third message comprises a first identity, and the first identity indicates the first node U01.

In one embodiment, the third message comprises a first field, and the first field indicates performing a data transmission in the RRC_INACTIVE state.

In one embodiment, the third message indicates the first node executing an MT-SDT.

In one embodiment, the third message indicates that the first node receives a multicast MBS in the RRC_INACTIVE state.

In one embodiment, the third message comprising a first field and the third message comprising a second field is used to indicate that the first node U01 performs a data transmission in the RRC_INACTIVE state; the second field is set as a first identity, and the first identity indicates the first node U01.

In one embodiment, the first field is associated with the second field.

In one embodiment, the first field is for the second field.

In one embodiment, the first field and the second field are associated with a same PagingRecord.

In one embodiment, the first field and the second field are two fields in a same PagingRecord.

In one embodiment, the first field and the second field belong to a same PagingRecord.

In one embodiment, the first field and the second field are associated with a same Temporary Mobile Group Identity (TMGI) in a same PagingRecordList.

In one embodiment, the first field and the second field belong to a same TMGI.

In one embodiment, the first field and the second field belong to a same RRC field whose name comprises PagingRecord.

In one embodiment, a name of the first field comprises at least one of mt or ul or sdt.

In one embodiment, the first field is set as a first value, and the first value indicates performing data transmission in the RRC_INACTIVE state.

In one embodiment, the first field being set to a first value indicates performing data transmission in the RRC_INACTIVE state.

In one embodiment, a name of the first value comprises at least one of mt or ul or sdt.

In one embodiment, a name of the first value is a character string.

In one embodiment, a name of the first value is true.

In one embodiment, the first field is set as a first value, and a name of the first value is mt-sdt.

In one embodiment, the first field is set as a first value, and a name of the first value is ul-sdt.

In one embodiment, the first field is set as a first value, and a name of the first value is sdt.

In one embodiment, the first field is set as a first value, and a name of the first value is imbs.

In one embodiment, the first field is set as a first value, and a name of the first value comprises at least one of inactive or mbs or i.

In one embodiment, the first field is set as a first value, and a name of the first value comprises at least one of inactive or sdt or mt or mo or dl or ul or i.

In one embodiment, the first identity is a Temporary Mobile Group Identity (TMG), and the first node has joined in an MBS session indicated by the TMGI.

In one subembodiment of the above embodiment, a TMGI is used to indicate an MBS session associated with a multicast MRB.

In one subembodiment of the above embodiment, the first message comprises a PagingGroupList-r17 field, the PagingGroupList-r17 field comprises at least one TMGI field, and a TMGI field in the at least one TMGI field indicates the first identity.

In one subembodiment of the above embodiment, the TMGI field in the at least one TMGI field is set as the first identity.

In one subembodiment of the above embodiment, the at least one TMGI field comprises a PLMN index (plmn-Id-r17) and a service index (serviceId-r17).

In one embodiment, the first identity matches a fullI-RNTI of the first node U01.

In one embodiment, the first identity is equal to a fullI-RNTI of the first node U01.

In one embodiment, the first identity is a non-negative integer.

In one embodiment, the first identity is a bit string.

In one embodiment, the first identity is a fullI-RNTI, the fullI-RNTI is set as I-RNTI-Value, and the I-RNTI-Value is a BIT STRING.

In one embodiment, the first identity is an I-RNTI-Value, and the I-RNTI-Value is a BIT STRING.

In one embodiment, a length of the above bit string is a positive integer number of bit(s).

In one embodiment, a length of the above bit string is 48 bits.

In one embodiment, the third message comprises a PagingRecordList field, the PagingRecordList comprises at least one PagingRecord field, a PagingRecord field in the at least one PagingRecord field comprises a ue-Identity field, the ue-Identity field comprises a PagingUE-Identity field, the PagingUE-Identity field comprises a fullI-RNTI field, the fullI-RNTI field comprises an I-RNTI-Value field, and the I-RNTI-Value field indicates the first identity.

In one embodiment, the second field is an I-RNTI-Value field.

In one embodiment, the second field is a fullI-RNTI field.

In one embodiment, the second field is a ue-Identity field.

In one embodiment, the second field is a PagingUE-Identity field.

In one embodiment, the second field is a TMGI field.

In one embodiment, at least the third message indicates that the first node performing data transmission in the RRC_INACTIVE state is used to trigger the second message.

In one embodiment, as a response to the third message being received, the second message is transmitted.

In one embodiment, as a response to the third message is received and the third message indicates that the first node U01 performs data transmission in the RRC_INACTIVE state, the second message is transmitted.

In one embodiment, the dotted box F7.1 is optional.

In one embodiment, the dotted box F7.1 exists.

In one embodiment, the dotted box F7.1 does not exist.

In one embodiment, if the dotted box F7.1 exists, the second message is triggered by the third message.

In one embodiment, if the dotted box F7.1 does not exist, the second message is triggered by a higher layer of the RRC layer.

In one embodiment, only if [(system frame number×10)+subframe number] modulo (the first time length)=(the first offset) modulo (the first time length), or, only if [(system frame number×10)+subframe number] modulo (the first time length)=the first offset, start the first timer.

In one embodiment of the above embodiment, a time when the first timer is started is related to a beginning of a subframe indexed by the subframe number.

In one subembodiment of the embodiment, the first timer is started at a time after a beginning of a subframe indexed by the subframe number passes the second offset.

In one subembodiment of the embodiment, the first timer is started after a beginning of a subframe indexed by the subframe number passes the second offset.

### Embodiment 8

Embodiment 8 illustrates a flowchart of radio signal transmission according to another embodiment in the present application, as shown in FIG. 8. It is particularly underlined that the order illustrated in the embodiment does not put constraints over sequences of signal transmissions and implementations.

The first node U01 monitors a PDCCH for a first candidate RNTI set within a first time interval in step S8101, the first candidate RNTI set comprises at least one first RNTI, the first RNTI is not a P-RNTI; in step S8102, within the second time interval, receives a first DCI; in step S8103, within the second time interval, receives a first paging message.

The second node N02 transmits the first DCI in step S8201; transmits the first paging message in step S8202.

In embodiment 8, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node U01 is in RRC_INACTIVE state; the first DCI is scrambled by the P-RNTI, the first DCI indicates scheduling information of a PDSCH, and the PDSCH is used to carry at least the first paging message.

In one embodiment, within the second time interval, the first node U01 needs to monitor a paging channel for an RAN-initiated paging.

In one embodiment, the “within the second time interval, the first node U01 needs to monitor a paging channel for an RAN-initiated paging” comprises: if a paging occasion needs to monitor a paging channel for an RAN-initiated paging within a paging DRX period of the first node U01 belongs to the second time interval, the first node U01 needs to monitor a paging channel for an RAN-initiated paging.

In one subembodiment of the embodiment, if a paging occasion needs to monitor a paging channel for an RAN-initiated paging within a paging DRX period of the first node U01 belongs to the first time interval, the first node U01 needs to monitor a paging channel for an RAN-initiated paging.

In one subembodiment of the embodiment, if a paging occasion needs to monitor a paging channel for an RAN-initiated paging within a paging DRX period of the first node U01 belongs to the first time interval, the first node U01 does not need to monitor a paging channel for an RAN-initiated paging.

In one embodiment, for a paging occasion needs to monitor a paging channel for an RAN-initiated paging within a paging DRX period of the first node U01, whether the first node U01 needs to monitor a paging channel for an RAN-initiated paging is related to whether the paging occasion belongs to a DRX inactive time or a DRX active time of the first DRX operation.

In one subembodiment of the embodiment, if a paging occasion needs to monitor a paging channel for an RAN-initiated paging within a paging DRX period of the first node U01 belongs to a DRX inactive time of the first DRX operation, the first node U01 needs to monitor a paging channel for an RAN-initiated paging.

In one subembodiment of the embodiment, if a paging occasion needs to monitor a paging channel for an RAN-initiated paging within a paging DRX period of the first node U01 belongs to a DRX active time of the first DRX operation, the first node U01 does not need to monitor a paging channel for an RAN-initiated paging.

In one subembodiment of the embodiment, for a paging occasion needs to monitor a paging channel for an RAN-initiated paging within a paging DRX period of the first node U01, whether the first node U01 needs to monitor a paging channel for an RAN-initiated paging is unrelated to whether the paging occasion belongs to a DRX inactive time or a DRX active time of the first DRX operation.

In one subembodiment of the embodiment, whether a paging occasion needs to monitor a paging channel for an RAN-initiated paging within a paging DRX period of the first node U01 belongs to DRX inactive time or DRX active time of the first DRX operation, the first node U01 needs to monitor a paging channel for an RAN-initiated paging.

In one embodiment, for a paging occasion needs to monitor a paging channel for an RAN-initiated paging within a paging DRX period of the first node U01, whether the first node U01 needs to monitor a paging channel for an RAN-initiated paging is related to whether the paging occasion belongs to a DRX inactive time or DRX active time of the first DRX operation.

In one embodiment, for a paging occasion needs to monitor a paging channel for an RAN-initiated paging within a paging DRX period of the first node U01, whether the first node U01 needs to monitor a paging channel for an RAN-initiated paging is unrelated to whether the paging occasion belongs to a DRX inactive time or DRX active time of the first DRX operation.

In one embodiment, whether a paging occasion needs to monitor an RAN-initiated paging within a paging DRX period of the first node U01 belongs to a DRX active time or DRX inactive time of the first DRX operation, the first node does not need to monitor a paging channel for an RAN-initiated paging.

In one embodiment, the first node U01 monitors a paging channel for an RAN-initiated paging through the P-RNTI.

In one embodiment, the first paging message is a paging initiated by RAN.

In one embodiment, the first DCI is received on a paging channel.

In one embodiment, the first DCI is a physical-layer signaling.

In one embodiment, the first DCI is a downlink signaling.

In one embodiment, the first DCI is downlink control information.

In one embodiment, a format of the first DCI is DCI format 1_0.

In one embodiment, the first DCI is used to schedule a PDSCH.

In one embodiment, the first DCI comprises a Short Messages Indicator field and the Short Messages Indicator being set as 01 or 11 is used to determine that the first DCI indicates the scheduling information of the PDSCH.

In one embodiment, a Frequency domain resource assignment field, a Time domain resource assignment field, a VRB-to-PRB mapping field, a Modulation and coding scheme field, and a TB scaling field in the first DCI indicate scheduling information of a PDSCH.

In one embodiment, the first paging message is an RRC message.

In one embodiment, a Transport Channel (TB) of the first paging message is a paging channel.

In one embodiment, a logical channel of the first paging message is a PCCH.

In one embodiment, the first paging message is a paging message.

In one embodiment, the first paging message comprises at least one PagingRecord field.

In one embodiment, the first paging message comprises at least one RRC field whose name comprises PagingRecord.

In one embodiment, the first paging message comprises the first identity.

In one embodiment, the first paging message comprises a fullI-RNTI, and the fullI-RNTI matches a fullI-RNTI of the first node.

In one embodiment, the first paging message comprises a TMGI, and the first node U01 joins an MBS session indicated by the TMGI.

In one embodiment, the first node U01 receives the first paging message according to the scheduling information of the PDSCH indicated by the first DCI.

In one embodiment, the “the first SCI being scrambled by the P-RNTI” comprises: the first node U01 monitors a PDCCH for the P-RNTI, and receives the first DCI on the PDCCH for the P-RNTI.

In one embodiment, the “the first SCI being scrambled by the P-RNTI” comprises: the first DCI is identified by the P-RNTI.

In one embodiment, the “the first SCI being scrambled by the P-RNTI” comprises: a CRC of the first DCI is scrambled by the P-RNTI.

In one embodiment, the scheduling information of the PDSCH comprises at least one of a frequency-domain position, a time-domain position, mapping from Virtual resource block (VRB) to Physical resource block (PRB), Modulation and coding scheme (MCS) or TB scaling of the PDSCH.

In one embodiment, the first paging message is transmitted on the PDSCH.

Typically, the PDSCH carries only the first paging message.

### Embodiment 9

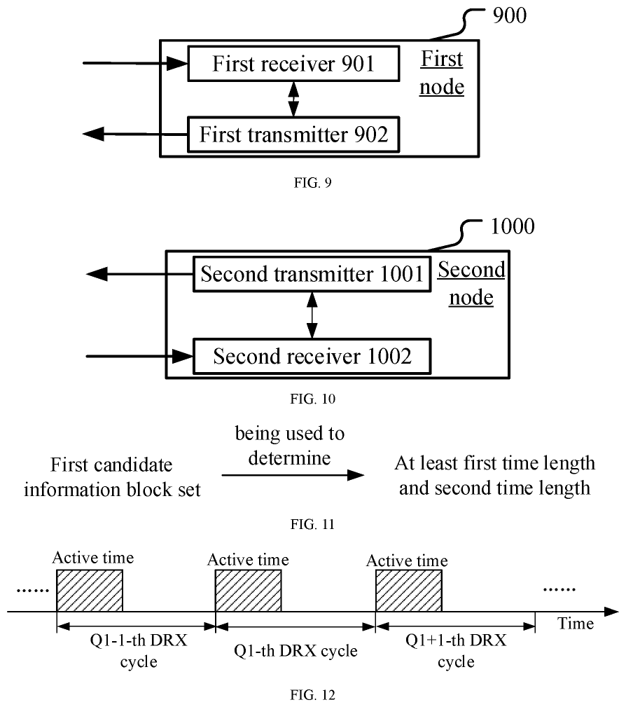

Embodiment 9 illustrates a structure block diagram of a processor in a first node according to one embodiment of the present application, as shown in FIG. 9. In FIG. 9, a processor 900 of a first node comprises a first receiver 901 and a first transmitter 902.

The first receiver 901 monitors a PDCCH for a first candidate RNTI set within a first time interval, the first candidate RNTI set comprises at least one first RNTI, the first RNTI is not a P-RNTI;

In embodiment 9, within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the first receiver 901, within the second time interval, receives a first DCI, and receives a first paging message; herein, the first DCI is scrambled by the P-RNTI, the first DCI indicates scheduling information of a PDSCH, and the PDSCH is used to carry at least the first paging message.

In one embodiment, a first processor, at a beginning of the given time interval, starts a first timer; herein, the second time length is used to determine a running time of the first timer.

In one embodiment, the first receiver 901 receives a first MAC PDU; a first processor, as a response to the first MAC PDU being correctly received, stopping the first timer; herein, the first MAC PDU comprises at least a first MAC SDU; the first MAC PDU does not comprise a MAC subheader with an LCID field set to 59 or 60.

In one embodiment, the first receiver 901 receives a first message, the first message indicates that the first node enters into or maintains the RRC_INACTIVE state; herein, the first message is an RRC message; within a time interval from a time when the first message is received to a beginning of the given time interval, the first node does not receive any RRC message indicating that the first node enters into or maintains the RRC_INACTIVE state.

In one embodiment, the first transmitter 902 transmits a second message in the RRC_INACTIVE state, the second message is used to initiate a data transmission procedure in the RRC_INACTIVE state; a first processor, accompanying the second message, recovers each radio bearer in a first radio bearer set; herein, the first radio bearer set comprises at least one radio bearer, and the first radio bearer set does not comprise SRB1; data transmission procedure in the RRC_INACTIVE state is used to determine monitoring a PDCCH for a first candidate RNTI set.

In one embodiment, the first transmitter 902 receives a third message in the RRC_INACTIVE state, and the third message indicates that the first node performs a data transmission in the RRC_INACTIVE state; herein, the third message is used to trigger the second message.

In one embodiment, a first candidate information block set is used to determine that a PDCCH for the first candidate RNTI set is not monitored within the second time interval, the first candidate information block set is used to determine at least the first time length and the second time length, and the first candidate information block set comprises at least one candidate information block.

In one embodiment, the first receiver 901 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 901 comprises the antenna 452, the receiver 454, the multi-antenna receiving processor 458 and the receiving processor 456 in FIG. 4 of the present application.

In one embodiment, the first receiver 901 comprises the antenna 452, the receiver 454 and the receiving processor 456 in FIG. 4 of the present application.

In one embodiment, the first transmitter 902 comprises the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 902 comprises the antenna 452, the transmitter 454, the multi-antenna transmitting processor 457 and the transmitting processor 468 in FIG. 4 of the present application.

In one embodiment, the first transmitter 902 comprises the antenna 452, the transmitter 454 and the transmitting processor 468 in FIG. 4 of the present application.

In one embodiment, the first processor belongs to the first transmitter 902.

In one embodiment, the first processor belongs to the first receiver 901.

In one embodiment, the first processor belongs to at least one of the first receiver 901 or the first transmitter 902.

### Embodiment 10

Embodiment 10 illustrates a structure block diagram of a processor in a second node according to one embodiment of the present application, as shown in FIG. 10. In FIG. 10, a processor 1000 in a second node comprises a second transmitter 1001 and a second receiver 1002.

The second transmitter 1001 executes a transmission for a first RNTI on a PDCCH, and the first RNTI is not a P-RNTI;

In embodiment 10, a node identified by the first RNTI monitors a PDCCH for a first candidate RNTI set within a first time interval, and the first candidate RNTI set comprises at least the first RNTI; within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

In one embodiment, the second transmitter 1001, within the second time interval, transmits a first DCI, and transmits a first paging message; herein, the first DCI is scrambled by the P-RNTI, the first DCI indicates scheduling information of a PDSCH, and the PDSCH is used to carry at least the first paging message.

In one embodiment, at a beginning of the given time interval, a first timer is started; the second time length is used to determine a running time of the first timer.

In one embodiment, the second transmitter 1001 transmits a first MAC PDU; herein, the first MAC PDU being correctly received is used to determine stopping the first timer; the first MAC PDU comprises at least a first MAC SDU; the first MAC PDU does not comprise a MAC subheader with an LCID field set to 59 or 60.

In one embodiment, the second transmitter 1001 transmits a first message, the first message indicates that the first node enters into or maintains the RRC_INACTIVE state; herein, the first message is an RRC message; within a time interval from a time when the first message is received to a beginning of the given time interval, the first node does not receive any RRC message indicating that the first node enters into or maintains the RRC_INACTIVE state.

In one embodiment, the second receiver 1002 receives a second message in the RRC_INACTIVE state, the second message is used to initiate a data transmission procedure in the RRC_INACTIVE state; herein, accompanying the second message, each radio bearer in a first radio bearer set is recovered; the first radio bearer set comprises at least one radio bearer, and the first radio bearer set does not comprise SRB1; data transmission procedure in the RRC_INACTIVE state is used to determine monitoring a PDCCH for a first candidate RNTI set.

In one embodiment, the second transmitter 1001 transmits a third message in the RRC_INACTIVE state, and the third message indicates that the first node performs a data transmission in the RRC_INACTIVE state; herein, the third message is used to trigger the second message.

In one embodiment, a first candidate information block set is used to determine that a PDCCH for the first candidate RNTI set is not monitored within the second time interval, the first candidate information block set is used to determine at least the first time length and the second time length, and the first candidate information block set comprises at least one candidate information block.

In one embodiment, the second transmitter 1001 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1001 comprises the antenna 420, the transmitter 418, the multi-antenna transmitting processor 471 and the transmitting processor 416 in FIG. 4 of the present application.

In one embodiment, the second transmitter 1001 comprises the antenna 420, the transmitter 418 and the transmitting processor 416 in FIG. 4 of the present application.

In one embodiment, the second receiver 1002 comprises the antenna 420, the receiver 418, the multi-antenna receiving processor 472, the receiving processor 470, the controller/processor 475 and the memory 476 in FIG. 4 of the present application.

In one embodiment, the second receiver 1002 comprises the antenna 420, the receiver 418, the multi-antenna receiving processor 472 and the receiving processor 470 in FIG. 4 of the present application.

In one embodiment, the second receiver 1002 comprises the antenna 420, the receiver 418 and the receiving processor 470 in FIG. 4 of the present application.

### Embodiment 11

Embodiment 11 illustrates a schematic diagram of a first candidate information block set being used to determine at least a first time length and a second time length according to one embodiment of the present application, as shown in FIG. 11.

In embodiment 11, a first candidate information block set is used to determine that a PDCCH for the first candidate RNTI set is not monitored within the second time interval, the first candidate information block set is used to determine at least the first time length and the second time length, and the first candidate information block set comprises at least one candidate information block.

In one embodiment, each candidate information block in the first candidate information block set is one of an RRC field or an RRC IE.

In one embodiment, each candidate information block in the first candidate information block set is one of an RRC field or an RRC IE or a MAC CE.

In one embodiment, the first candidate information block set comprises a first candidate information block, and the first candidate information block indicates at least a former of the first offset or the first time length.

In one subembodiment of the embodiment, the first candidate information block indicates the first offset and the first time length; the second candidate information block is not used to indicate the first time length.

In one subsidiary embodiment of the subembodiment, the first candidate information block set does not comprise the second candidate information block.

In one subsidiary embodiment of the subembodiment, the second candidate information block is not configured.

In one subsidiary embodiment of the subembodiment, configuration of the second candidate information block is not used.

In one subembodiment of the embodiment, the first candidate information block indicates the first offset, and the second candidate information block indicates the first time length.

In one subembodiment of the embodiment, the first candidate information is a drx-LongCycleStartOffset field.

In one subembodiment of the embodiment, the first candidate information is a drx-CycleStartOffset field.

In one subembodiment of the embodiment, the first candidate information is a drx-LongCycleStartOffsetSDT field.

In one subembodiment of the embodiment, a name of the first candidate information block comprises at least one of drx-LongCycleStartOffset or SDT or sdt or MT or mt.

In one subembodiment of the embodiment, a name of the first candidate information block comprises at least one of drx or Start or Offset or SDT or sdt or MT or mt.

In one subembodiment of the embodiment, the first candidate information is a drx-CycleStartOffset field.

In one subembodiment of the embodiment, a name of the first candidate information block comprises LongCycleStartOffset; the first DRX operation is a long DRX; the first candidate information block indicates the first offset and the first time length.

In one subembodiment of the embodiment, a name of the second candidate information block comprises ShortCycle, and a name of the first candidate information block comprises LongCycleStartOffset; the first DRX operation is a short DRX; the first candidate information block indicates the first offset, and the second candidate information block indicates the first time length.

In one embodiment, the first candidate information block set comprises a second candidate information block, and the second candidate information block indicates the first time length.

In one subembodiment of the embodiment, the second candidate information is a drx-LongCycle field.

In one subembodiment of the embodiment, the second candidate information is a drx-Cycle field.

In one subembodiment of the embodiment, the second candidate information is a drx-LongCycleSDT field.

In one subembodiment of the embodiment, a name of the second candidate information block comprises at least one of drx or Long or Cycle or SDT or sdt or MT or mt.

In one subembodiment of the embodiment, the second candidate information block is a drx-ShortCycle field.

In one subembodiment of the embodiment, the second candidate information block is a drx-Cycle SDT field.

In one subembodiment of the embodiment, the second candidate information block is a drx-ShortCycleSDT field.

In one subembodiment of the embodiment, a name of the second candidate information block comprises at least one of drx-ShortCycle or SDT or sdt or MT or mt.

In one embodiment, the first candidate information block set comprises a third candidate information block, and the third candidate information block indicates the second time length.

In one subembodiment of the embodiment, the third candidate information block is a drx-onDurationTimer field.

In one subembodiment of the embodiment, the third candidate information block is a drx-onDurationTimerSDT field.

In one subembodiment of the embodiment, a name of the third candidate information block comprises at least one of drx-onDurationTimer or SDT or sdt or MT or mt.

In one embodiment, the first candidate information block set comprises a fourth candidate information block, and the fourth candidate information block indicates the second offset.

In one subembodiment of the embodiment, the fourth candidate information block is a drx-SlotOffset field.

In one subembodiment of the embodiment, the fourth candidate information block is a drx-SlotOffsetSDT field.

In one subembodiment of the embodiment, a name of the fourth candidate information block comprises at least one of drx-SlotOffset or SDT or sdt or MT or mt.

In one embodiment, the first candidate information block set comprises a fifth candidate information block, and the fifth candidate information block indicates an index of the first time length in the first candidate time length set.

In one subembodiment of the embodiment, a value of the fifth candidate information block is set as an index of the first time length in the first candidate time length set.

In one subembodiment of the embodiment, the fifth candidate information block comprises an index of the first time length in the first candidate time length set.

In one subembodiment of the embodiment, the fifth candidate information block comprises the first offset.

In one subembodiment of the embodiment, the fifth candidate information block comprises an index of the first time length in the first candidate time length set and the first offset.

In one subembodiment of the embodiment, the fifth candidate information block comprises the first time length and the first offset.

In one subembodiment of the embodiment, the fifth candidate information block is an RRC IE or an RRC field.

In one subembodiment of the embodiment, the fifth candidate information block is a MAC CE.

In one subembodiment of the embodiment, the fifth candidate information block is a MAC field.

In one subembodiment of the embodiment, an order of each candidate time length in the first candidate time length set in an RRC field is used to determine an index of each candidate time length in the first candidate time length set.

In one subembodiment of the above embodiment, the fifth candidate information block comprises 5 bits.

In one subembodiment of the above embodiment, the fifth candidate information block comprises 6 bits.

In one embodiment, the first candidate information block set comprises at least one of the first candidate information block, or the second candidate information block, or the third candidate information block, or the fourth candidate information or the fifth candidate information block.

In one embodiment, the first message comprises at least one candidate information block in the first candidate information block set.

In one subembodiment of the above embodiment, a SuspendConfig field in the first message comprises at least one candidate information block in the first candidate information block set.

In one subembodiment of the above embodiment, an RRC field whose name comprises SuspendConfig in the first message comprises at least one candidate information block in the first candidate information block set.

In one embodiment, the third message comprises at least one candidate information block in the first candidate information block set.

In one subembodiment of the above embodiment, a PagingRecord field in the third message comprises at least one candidate information block in the first candidate information block set.

In one subembodiment of the above embodiment, a PagingRecord field in the third message comprises the first identity, and the PagingRecord field comprises at least one candidate information block in the first candidate information block set.

In one subembodiment of the above embodiment, an RRC field whose name comprises PagingRecord in the third message comprises at least one candidate information block in the first candidate information block set.

In one subembodiment of the above embodiment, an RRC field whose name comprises PagingRecord in the third message comprises the first identity, and the PagingRecord field comprises at least one candidate information block in the first candidate information block set.

In one subembodiment of the above embodiment, the third message comprises a first field and the third message comprises a second field; the second field is set as a first identity, and the first identity indicates the first node; the first field, the second field and at least one candidate information block in the first candidate information block set belongs to a same PagingRecord field.

In one embodiment, an SIB1 message comprises at least one candidate information block in the first candidate information block set.

In one subembodiment of the above embodiment, an sdt-ConfigCommon field in the SIB1 comprises at least one candidate information block in the first candidate information block set.

In one subembodiment of the above embodiment, an RRC field whose name comprises sdt-ConfigCommon in the SIB1 comprises at least one candidate information block in the first candidate information block set.

In one embodiment, as a response to the second message being transmitted, a fourth message is received, and the fourth message comprises at least one candidate information block in the first candidate information block set.

In one subembodiment of the embodiment, the fourth message is an RRC message.

In one subsidiary embodiment of the subembodiment, the fourth message is transmitted through a DCCH.

In one subsidiary embodiment of the subembodiment, the fourth message is transmitted through SRB1.

In one subsidiary embodiment of the subembodiment, the fourth message is an RRCReconfiguration message.

In one subsidiary embodiment of the subembodiment, a DRX-Config field in the fourth message comprises at least one candidate information block in the first candidate information block set.

In one subsidiary embodiment of the subembodiment, a DRX-Config field in the fourth message comprises at least one candidate information block in the first candidate information block set.

In one subembodiment of the embodiment, the fourth message is a MAC layer signaling.

In one subsidiary embodiment of the subembodiment, the fourth message is a MAC CE.

In one subembodiment of the above embodiment, the fourth message comprises the fifth candidate information block.

In one embodiment, the at least one candidate information block comprises all candidate information blocks in the first candidate information block set.

In one embodiment, the at least one candidate information block comprises partial candidate information blocks in the first candidate information block set.

In one embodiment, the first message comprises at least one candidate information block in the first candidate information block set, and the third message comprises at least one candidate information block in the first candidate information block set.

In one embodiment, the third message comprises at least one candidate information block in the first candidate information block set, and an SIB1 message comprises at least one candidate information block in the first candidate information block set.

In one embodiment, when the fifth candidate information block is received, or after the fifth candidate information block is received, start executing the first DRX operation.

In one embodiment, when a last candidate information block in the first candidate information block set is received, or, after a last candidate information block in the first candidate information block set is received, the first DRX operation is started to be executed.

In one embodiment, if a MAC SDU corresponding to the second message is transmitted through message 3 or message A in a random access procedure, and after a random access procedure is successfully completed, the first DRX operation is started to be executed.

In one embodiment, if a MAC SDU corresponding to the second message is transmitted through CG resources of a CG-SDT procedure, and after an initial transmission of a CG-SDT procedure is successfully completed, the first DRX operation is started to be executed.

### Embodiment 12

Embodiment 12 illustrates a schematic diagram of a first DRX operation according to one embodiment of the present application, as shown in FIG. 12. In FIG. 12, the horizontal axis represents time; Q1−1-th DRX period, Q1-th DRX period and Q1+1 DRX period represent continuous three DRX periods in the first DRX operation in time domain; the ellipses represent other DRX periods in the first DRX operation; a length of the slash-filled box represents a DRX active time of the first DRX operation; a length of the blank in each DRX period represents a DRX inactive time of the first DRX operation.

In one embodiment, the first parameter set is used to determine a beginning of each DRX period.

In one embodiment, at a beginning of each DRX period, start a first timer.

In one embodiment, a length of each DRX period is variable.

In one embodiment, a length of each DRX period is related to a length of a DRX active time.

In one embodiment, a length of each DRX period is equal to the first time length.

In one embodiment, a length of a DRX active time in the first DRX operation is equal.

In one embodiment, a length of a DRX active time in the first DRX operation is variable.

In one embodiment, a length of a DRX active time in the first DRX operation is related to at least the first timer.

In one embodiment, a length of a DRX active time in the first DRX operation is related to at least the first timer and the second timer.

In one embodiment, a length of a DRX active time in the first DRX operation is related to at least the first timer, a second timer and a third timer.

In one embodiment, a length of a DRX active time in the first DRX operation is unrelated to at least one of the second timer or the third timer.

In one embodiment, the second timer is a drx-InactivityTimer.

In one embodiment, the second timer is a drx-InactivityTimerSDT.

In one embodiment, a name of the second timer comprises drx-InactivityTimer.

In one embodiment, the third timer is drx-RetransmissionTimerDL.

In one embodiment, the third timer is drx-RetransmissionTimerDLSDT.

In one embodiment, a name of the third timer comprises drx-RetransmissionTimerDL.

In one embodiment, a length of a DRX active time in the first DRX operation comprises a time when the first timer is running, a time when the second timer is running, and a time when the third timer is running.

In one embodiment, a length of a DRX active time in the first DRX operation comprises a time when the first timer is running and a time when the second timer is running.

In one embodiment, a length of a DRX active time in the first DRX operation is related to at least one of ra-ContentionResolutionTimer or msgB-ResponseWindow.

In one embodiment, a length of a DRX active time in the first DRX operation is unrelated to at least one of ra-ContentionResolutionTimer or msgB-ResponseWindow.

In one embodiment, a length of a DRX active time in the first DRX operation is related to drx-RetransmissionTimerUL or drx-RetransmissionTimerSL.

In one embodiment, a length of a DRX active time in the first DRX operation is unrelated to drx-RetransmissionTimerUL or drx-RetransmissionTimerSL.

In one embodiment, a length of a DRX active time in the first DRX operation is related to whether an SR is transmitted on a PUCCH.

In one embodiment, a length of a DRX active time in the first DRX operation is unrelated to whether an SR is transmitted on a PUCCH.

In one embodiment, a time when drx-InactivityTimer is running in the first DRX operation belongs to a DRX active time.

In one embodiment, a time when drx-RetransmissionTimerDL or drx-RetransmissionTimerUL or drx-RetransmissionTimerSL in the first DRX operation is running belongs to a DRX active time in the first DRX operation.

In one embodiment, a time when drx-RetransmissionTimerDL or drx-RetransmissionTimerUL or drx-RetransmissionTimerSL in the first DRX operation is running does not belong to a DRX active time in the first DRX operation.

In one embodiment, a time when ra-ContentionResolutionTimer or msgB-ResponseWindow is running in the first DRX operation belongs to a DRX active time in the first DRX operation.

In one embodiment, a time when ra-ContentionResolutionTimer or msgB-ResponseWindow is running in the first DRX operation does not belong to a DRX active time in the first DRX operation.

In one embodiment, an SR in the first DRX operation is transmitted on a PUCCH and a pending time belongs to a DRX active time.

In one embodiment, an SR in the first DRX operation is transmitted on a PUCCH and a pending time does not belong to a DRX active time.

In one embodiment, a length of the given time interval is equal to the first time length; the given time interval is one of the Q1−1-th DRX period or the Q1-th DRX period or the Q1+1-th DRX period; the first time interval is a DRX active time in the DRX period; the second time interval is a DRX inactive time in the DRX period.

In one embodiment, at least one of the Q1−1-th DRX period or Q1-th DRX period or Q1+1 DRX period exists.

In one embodiment, the ellipsis exists.

In one embodiment, the ellipsis does not exist.

In one embodiment, Q1 is equal to 2.

In one embodiment, Q1 is greater than 2.

In one embodiment, in the embodiment, for convenience of description, a length of the given time interval is equal to the first time length, and the embodiment does not limit a length of the given time interval to equal the first time length.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, monitoring a PDCCH for a first candidate RNTI set within a first time interval, the first candidate RNTI set comprising at least a first RNTI, the first RNTI not being a P-RNTI;
wherein within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

2. The first node according to claim 1, comprising:
the first receiver, within the second time interval, receiving a first DCI, and receiving a first paging message;
wherein the first DCI is scrambled by the P-RNTI, the first DCI indicates scheduling information of a PDSCH, and the PDSCH is used to carry at least the first paging message.

3. The first node according to claim 1, comprising:
a first processor, at a beginning of the given time interval, starting a first timer;
wherein the second time length is used to determine a running time of the first timer.

4. The first node according to claim 3, comprising:
the first receiver, receiving a first MAC PDU; and
the first processor, as a response to the first MAC PDU being correctly received, stopping the first timer;
wherein the first MAC PDU comprises at least a first MAC SDU; the first MAC PDU does not comprise a MAC subheader with an LCID field set to 59 or 60.

5. The first node according to claim 1, comprising:
the first receiver, receiving a first message, the first message indicating that the first node enters into or maintains the RRC_INACTIVE state;
wherein the first message is an RRC message; within a time interval from a time when the first message is received to a beginning of the given time interval, the first node does not receive any RRC message indicating that the first node enters into or maintains the RRC_INACTIVE state.

6. The first node according to claim 1, comprising:
the first transmitter, transmitting a second message in the RRC_INACTIVE state, the second message being used to initiate a data transmission procedure in the RRC_INACTIVE state; and
a first processor, accompanying the second message, recovering each radio bearer in a first radio bearer set;
wherein the first radio bearer set comprises at least one radio bearer, and the first radio bearer set does not comprise SRB1; data transmission procedure in the RRC_INACTIVE state is used to determine monitoring a PDCCH for a first candidate RNTI set.

7. The first node according to claim 6, comprising:
the first transmitter, receiving a third message in the RRC_INACTIVE state, the third message indicating that the first node performs a data transmission in the RRC_INACTIVE state;
wherein the third message is used to trigger the second message.

8. The first node according to claim 7, wherein the third message comprising a first field and the third message comprising a second field is used to indicate that the first node performs a data transmission in the RRC_INACTIVE state; the second field is set as a first identity, and the first identity indicates the first node.

9. The first node according to claim 8, wherein the first field and the second field are associated with a same PagingRecord.

10. The first node according to claim 8, wherein the first field is set as a first value, and a name of the first value comprises at least one of inactive or sdt or mt or mo or dl or ul or i.

11. The first node according to claim 1, wherein a first candidate information block set is used to determine that a PDCCH for the first candidate RNTI set is not monitored within the second time interval, the first candidate information block set is used to determine at least the first time length and the second time length, and the first candidate information block set comprises at least one candidate information block.

12. The first node according to claim 1, wherein the first node is not configured with any of a paging DRX operation, a DRX operation for MBS groupcast in the RRC_INACTIVE state, and a DRX operation for MBS broadcast in the RRC_INACTIVE state.

13. The first node according to claim 1, wherein within the first time interval, the first node does not need to monitor a paging channel for an RAN-initiated paging; within the second time interval, the first node needs to monitor a paging channel for an RAN-initiated paging.

14. The first node according to claim 1, wherein the first candidate RNTI set comprises at least one of a C-RNTI or a CS-RNTI, and the first candidate RNTI set does not comprise a P-RNTI; the first RNTI is any candidate RNTI in the first candidate RNTI set.

15. The first node according to claim 1, wherein if [(the system frame number×10)+the subframe number] modulo (the first time length)=(the first offset) modulo (the first time length), a subframe indexed by the subframe number is used to determine a beginning of the given time interval.

16. The first node according to claim 1, wherein if [(the system frame number×10)+the subframe number] modulo (the first time length)=the first offset, a subframe indexed by the subframe number is used to determine a beginning of the given time interval.

17. A second node for wireless communications, comprising:
a second transmitter, executing a transmission for a first RNTI on a PDCCH, the first RNTI not being a P-RNTI;
wherein a node identified by the first RNTI monitors a PDCCH for a first candidate RNTI set within a first time interval, and the first candidate RNTI set comprises at least the first RNTI; within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.

18. The second node according to claim 17, comprising:
a second receiver, receiving a second message in the RRC_INACTIVE state, the second message being used to initiate a data transmission procedure in the RRC_INACTIVE state;
wherein accompanying the second message, each radio bearer in a first radio bearer set is recovered; the first radio bearer set comprises at least one radio bearer, and the first radio bearer set does not comprise SRB1; data transmission procedure in the RRC_INACTIVE state is used to determine monitoring a PDCCH for a first candidate RNTI set.

19. The second node according to claim 18, comprising:
the second transmitter, transmitting a third message in the RRC_INACTIVE state, the third message indicating that the first node performs a data transmission in the RRC_INACTIVE state;
wherein the third message is used to trigger the second message.

20. A method in a first node for wireless communications, comprising:
monitoring a PDCCH for a first candidate RNTI set within a first time interval, the first candidate RNTI set comprising at least a first RNTI, the first RNTI not being a P-RNTI;
wherein within a second time interval, a PDCCH for the first candidate RNTI set is not monitored; the first time interval belongs to a given time interval, the second time interval belongs to the given time interval, and the first time interval and the second time interval are orthogonal in time domain; a first parameter set is used to determine a beginning of the given time interval, the first parameter set comprises at least one of a system frame number or a subframe number or a first time length; a length of the given time interval is related to the first time length, and the first time length is configurable; a length of the first time interval is related to a second time length, and the second time length is configurable; within the given time interval, the first node is in RRC_INACTIVE state.
